(19) United States
(12) Patent Application Publication
(10) Pub. No.: US 2015/0000956 A1
(43) Pub. Date: Jan. 1, 2015

(54) APPARATUS AND METHODS FOR JOINING DISSIMILAR MATERIALS

(71) Applicant: Alcoa Inc., Pittsburgh, PA (US)

(72) Inventor: Donald J. Spinella, Greensburg, PA (US)

(21) Appl. No.: 14/315,598

(22) Filed: Jun. 26, 2014

Related U.S. Application Data
(60) Provisional application No. 61/839,478, filed on Jun. 26, 2013.

(51) Int. Cl. B23K 11/20; H01B 5/00; B23K 11/34

(52) U.S. Cl. CPC B23K 11/20; B23K 11/34; H01B 5/002
USPC 174/126.2; 219/118; 219/78.16

(57) ABSTRACT

An apparatus and method for fastening dissimilar metals like steel and aluminum utilizes a spot welding machine. The metals are stacked with an aluminum body captured between steels. Heat from the welder's electric current softens the lower melting point aluminum allowing an indentation of the steel layer to penetrate the aluminum and weld to an opposing steel layer. The process may be used to join stacks with several layers of different materials and for joining different structural shapes.

### CROSS REFERENCE TO RELATED APPLICATIONS

The present application claims the benefit of U.S. Provisional Application No. 61/839,478, entitled Apparatus and Methods fort Joining Dissimilar Materials, filed Jun. 26, 2013, which is incorporated by reference in its entirety herein.

### FIELD

The present invention relates to welding apparatus and methods and more particularly, to methods for joining dissimilar materials, such as dissimilar metals.

### BACKGROUND

Various fasteners, apparatus and methods for joining and assembling parts or subunits are known, such as welding, riveting, threaded fasteners, etc. In some instances, there is a need to cost effectively join dissimilar metals, such as aluminum parts, subunits, layers, etc., to other parts, subunits, layers, etc. made from other materials, such as steel (bare, coated, low carbon, high strength, ultra high strength, stainless), titanium alloys, copper alloys, magnesium, plastics, etc. Solutions for these fastening problems include mechanical fastener/rivets in combination with an adhesive and/or a barrier layer to maintain adequate joint strength while minimizing corrosion, e.g., due to the galvanic effect present at a junction of dissimilar metals. Direct welding between aluminum and other materials is not commonly employed due to intermetallics generated by the aluminum and the other materials, which negatively affect mechanical strength and corrosion resistance. In cases where direct welding is employed, it is typically some type of solid-state welding (friction, upset, ultrasonic, etc.) or brazing/soldering technology in order to minimize the intermetallics, but the mechanical performance of such joints is sometimes poor or only applicable to unique joint geometries.

In the automotive industry, the incumbent technology for joining steel to steel is resistance spot welding (RSW), due to cost and cycle time considerations (less than 3 seconds per individual joint and which may be performed robotically). Known methods for joining aluminum to steel, include: use of conventional through-hole riveting/fasteners, self-pierce riveting (SPR), use of flow drill screws (FDS or by trade name of EJOTS), friction stir spot welding/joining (FSJ), friction bit joining (FBJ), and use of adhesives Each of these processes is more challenging than steel-to-steel resistance spot welding (RSW). For example, when high strength aluminum (above 240 MPa) is coupled to steel using SPR, the aluminum can crack during the riveting process. Further, high strength steels (>590 MPa) are difficult to pierce, requiring the application of high magnitude forces by large, heavy riveting guns. FSJ is not widely employed in the automotive industry since joint properties (primarily peel and cross tension) are low compared to SPR. In addition, FSJ requires very precise alignment and fitup. As the thickness of the joint increases, the cycle times for the process can increase dramatically where a 5 mm to 6 mm joint stack-up may require 7 to 9 seconds of total processing time, which is well above the 2 to 3 second cycle time of RSW when fabricating steel structures. FBJ employs a bit which is rotated through the aluminum and is then welded to the steel. This process requires very precise alignment and fit-up similar to FSJ and high forging forces are required for welding to steel. FDS involves rotating a screw into the work pieces, plasticizing one of the sheets, which then becomes interlocked with the screw's thread. FDS is typically applied from a single side and requires alignment with a pilot hole in the steel sheet, complicating assembly and adding cost. Alternative fasteners, apparatus and methods for joining and assembling parts or subunits therefore remain desirable.

### SUMMARY

The disclosed subject matter relates to methods for fastening metal members. In a first embodiment a first electrically conductive body made of a first material is fastened to a second electrically conductive body made from a second material dissimilar to the material of the first body using electrical resistance welding including the steps of: placing the first and second bodies together in physical and electrical contact, the first material having a lower melting point than the second material; placing an electrically conductive third body that is made of a third material that is weldable to the second material and which has a higher melting point than the first material in physical and electrical contact with the first material to form an electrically conductive stack inclusive of at least a portion of the first body, the second body and the third body; applying an electrical potential across the stack, inducing a current to flow through the stack and causing resistive heating, the resistive heating causing a softening of a least a portion of the first body; urging a softened portion of the third body through the softened portion of the first body toward the second body; and after the portion of the third body contacts the second body, welding the third body to the second body.

In another aspect of the present disclosure, the first material includes at least one of aluminum, magnesium and alloys thereof.

In another aspect of the present disclosure, the second material includes at least one of steel, titanium and alloys thereof.

In another aspect of the present disclosure, the third material includes at least one of steel, titanium and alloys thereof.

In another aspect of the present disclosure, a portion of the third body covers an upwelled portion of the first body that is displaced when the portion of the third body is urged through the first body.

In another aspect of the present disclosure, the first body, the second body and the third body are in the form of layers proximate where the third body is welded to the second body.

In another aspect of the present disclosure, the layers are sheet metal.

In another aspect of the present disclosure, at least one of the first body, the second body and the third body is in the form of a structural member.

In another aspect of the present disclosure, the electrical potential is applied in the course of direct resistance welding.

In another aspect of the present disclosure, the electrical potential is applied in the course of indirect resistance welding.

In another aspect of the present disclosure, the electrical potential is applied in the course of series resistance welding.

In another aspect of the present disclosure, the stack includes a plurality of bodies having a melting point less than a melting point of the second and third bodies.

In another aspect of the present disclosure, the second body and the third body are monolithic, the second body distinguishable from the third body by a fold and further including the steps of folding to make the fold and inserting the first body into the fold to make the stack prior to the step of applying an electrical potential across the stack.

In another aspect of the present disclosure, the folding results in a J shape.

In another aspect of the present disclosure, the folding results in a U shape.

In another aspect of the present disclosure, the step of folding is conducted a plurality of times to make a plurality of folds.

In another aspect of the present disclosure, the folding results in an S shape.

In another aspect of the present disclosure, the folding results in a W shape.

In another aspect of the present disclosure, a plurality of bodies are inserted into the plurality of folds.

In another aspect of the present disclosure, the step of welding simultaneously generates a plurality of welds.

In another aspect of the present disclosure, the folding results in a T shape with a bifurcated bottom portion and a top portion, and the step of inserting includes inserting the first body into the bifurcated bottom and the step of welding is conducted across the stack of the first body and the bifurcated bottom portion.

In another aspect of the present disclosure, further conducting the step of fastening another body to the top portion of the T shape.

In another aspect of the present disclosure, a force applied during the steps of urging and welding is adjustable is adjustable and further comprising the step of adjusting the force.

In another aspect of the present disclosure, the steps of adjusting the current and the force can be made to accommodate different thickness of the first body, second body and third body.

In another aspect of the present disclosure, the third layer and the second layer are not pierced during the steps of applying, urging and welding.

In another aspect of the present disclosure, a structure has a first electrically conductive body, a second electrically conductive body and a third electrically conductive body positioned proximate one another in physical and electrical contact, the first body having a lower melting point than the second and third bodies and being positioned between the second and third bodies, the second body being welded to the third body by electrical resistance welding extending through the first body, the first body being captured between the second body and the third body.

In another aspect of the present disclosure, the first body is in the form of an elongated channel and the second body is in the form of a web that extends across the elongated channel and folds back over itself at a fold defining the third body, a portion of the first body positioned in the fold and retained in the fold by the welding of the second body to the third body.

In another aspect of the present disclosure, the first body is in the form of a plate, the second and third bodies are in the form of beams having an L shaped cross-section, the first body being sandwiched between the second and third bodies.

In another aspect of the present disclosure, the structure further includes a plurality of plates and beams of L shaped cross-section.

In another aspect of the present disclosure, the first body is in the form of an I beam, the second body is in the form of an elongated channel insertable into a hollow defined by the I shape of the first body and the third body is in the form a plate positioned on a top portion of the I shape.

In another aspect of the present disclosure, the first, second and third bodies are each tubular, the second body capable of being inserted coaxially into at least a portion of the third body, the first body having dimensions permitting the insertion thereof between the second and third bodies.

In another aspect of the present disclosure, the first and second bodies are each tubular, the second body having dimensions permitting the insertion thereof within the first body, the third body being a plate positioned against the exterior of the first body adjacent the second body.

In another aspect of the present disclosure, the first and second bodies have at least one of a rectangular and circular cross-sectional shape.

In another aspect of the present disclosure, the first body is in the form of a tube, the second body is in the form of plate positioned against the interior of the first body, the first body having an opening with dimensions permitting the insertion there through of the second body, the third body being in the form of a plate positioned against the exterior of the first body proximate the second body, sandwiching the first body there between.

In another aspect of the present disclosure, the first body is in the form of an elongated channel and the second body is in the form of a channel that inserts into a hollow of the first body, the third body being in the form of a plate, the plate positioned proximate the second body sandwiching the first body there between.

In another aspect of the present disclosure, the first body is in the form of an elongated channel and the second body is in the form of a tube that inserts into a hollow of the first body, the third body being in the form of a plate, the plate positioned proximate the second body, sandwiching the first body there between.

In another aspect of the present disclosure, the first body is in the form of an elongated tube and the second body is in the form of a C shaped bracket that inserts into a hollow of the first body, the third body being in the form of a plate, the plate positioned proximate the second body, sandwiching the first body there between.

In another aspect of the present disclosure, the first body has an aperture allowing the insertion of welding electrodes.

In another aspect of the present disclosure, the first body is tubular and the second body is tubular, the first body having a side aperture allowing the insertion of the second body at an angle relative to the first body, the third body being in the form of a plate, the plate positioned proximate the second body, sandwiching the first body there between.

In another aspect of the present disclosure, the first body has a tab extending therefrom proximate the side aperture.

In another aspect of the present disclosure, the structure further includes a fourth body similar to the second body, the second and fourth bodies being mitered and joining at the aperture.

In another aspect of the present disclosure, the structure is replicated a plurality of times to form a truss structure.

In another aspect of the present disclosure, the structure further includes a fourth body similar to the second body and the first body has a second aperture, the second and fourth bodies inserting into the aperture and second aperture, respectively, along skew lines.

In another aspect of the present disclosure, further comprising a coating on at least one of the first material, the second material and the third material.

In another aspect of the present disclosure, the coating is at least one of aluminum alloy, galvanized, galvaneal and anti-corrosion paint.

In another aspect of the present disclosure, the coating is an adhesive.

### BRIEF DESCRIPTION OF THE DRAWINGS

For a more complete understanding of the present disclosure, reference is made to the following detailed description of exemplary embodiments considered in conjunction with the accompanying drawings.

FIG. 1 is a diagrammatic, cross-sectional view sequentially showing the joining of three layers of material by electrical resistance welding in accordance with an embodiment of the present disclosure.

FIG. 2 is a diagrammatic, cross-sectional view sequentially showing the joining of three layers of material by electrical resistance welding, the middle layer having a coating on each side, in accordance with an embodiment of the present disclosure.

FIG. 3 is a diagrammatic, cross-sectional view showing the joining of three structures by electrical resistance welding in accordance with an embodiment of the present disclosure.

FIG. 4 is a diagrammatic, cross-sectional view showing the joining of four structures by electrical resistance welding in accordance with an embodiment of the present disclosure.

FIG. 5 is a diagrammatic, cross-sectional view showing the joining of five structures by electrical resistance welding in accordance with an embodiment of the present disclosure.

FIG. 6 is a diagrammatic, cross-sectional view showing the joining of two structures, one of which has a “J” configuration, by electrical resistance welding in accordance with an embodiment of the present disclosure.

FIG. 7 is a diagrammatic, cross-sectional view showing the joining of three structures, one of which has a “J” configuration, by electrical resistance welding in accordance with an embodiment of the present disclosure.

FIG. 8 is a diagrammatic, cross-sectional view showing the joining of four structures, one of which has a “J” configuration, by electrical resistance welding in accordance with an embodiment of the present disclosure.

FIG. 9 is a diagrammatic, cross-sectional view showing the joining of two structures, one of which has an “S” configuration, by electrical resistance welding in accordance with an embodiment of the present disclosure.

FIG. 10 is a diagrammatic, cross-sectional view showing the joining of three structures, one of which has an “S” configuration, by electrical resistance welding in accordance with an embodiment of the present disclosure.

FIG. 11 is a diagrammatic, cross-sectional view showing the joining of two structures, one of which has a “U” configuration, by electrical resistance welding in accordance with an embodiment of the present disclosure.

FIG. 12 is a diagrammatic, cross-sectional view showing the joining of three structures, one of which has a “U” configuration, by electrical resistance welding in accordance with an embodiment of the present disclosure.

FIG. 13 is a diagrammatic, cross-sectional view showing the joining of three structures, one of which has a “W” configuration, by electrical resistance welding in accordance with an embodiment of the present disclosure.

FIG. 14 is a diagrammatic, cross-sectional view showing the joining of two structures, one of which has a “T” configuration, by electrical resistance welding in accordance with an embodiment of the present disclosure.

FIG. 15 is a diagrammatic, cross-sectional view showing the assembly of four intersecting structures into a “+” shaped configuration by four “L” shaped brackets, by electrical resistance welding in accordance with an embodiment of the present disclosure.

FIG. 16 is a diagrammatic, perspective view of a composite beam formed from mating structures and joined by electrical resistance welding in accordance with an embodiment of the present disclosure.

FIGS. 17a and 17b are exploded and perspective views, respectively, of an assembly joined by electrical resistance welding in accordance with an embodiment of the present disclosure.

FIGS. 18a and 18b are diagrammatic, cross-sectional views showing the sequential assembly of a first structure to a plate using “T” shaped brackets joined by electrical resistance welding in accordance with an embodiment of the present disclosure.

FIGS. 19 and 20 are an exploded view of an assembly structures to be joined by electrical resistance welding in accordance with an embodiment of the present disclosure.

FIG. 21 is a perspective view of an assembly of the structures of FIGS. 19 and 20.

FIG. 22 is a cross-sectional view of the assembly of FIG. 21 taken along section line 22-22 and looking in the direction of the arrows.

FIG. 23 is an exploded view of an assembly of structures to be joined by electrical resistance welding in accordance with an embodiment of the present disclosure.

FIG. 24 is a cross-sectional view of a stack-up of the structures shown in FIG. 23.

FIG. 25 is a diagrammatic, cross-sectional view of a stack-up of alternative structures for those shown in FIG. 24 and ready to be welded in accordance with an embodiment of the present disclosure.

FIG. 26 is a diagrammatic, cross-sectional view of a stack-up of alternative structures for those shown in FIG. 24 and ready to be welded in accordance with an embodiment of the present disclosure.

FIG. 27 is a diagrammatic, cross-sectional view of a stack-up of alternative structures for those shown in FIG. 24 and ready to be welded in accordance with an embodiment of the present disclosure.

FIG. 28 is an exploded view of an assembly of structures to be joined by electrical resistance welding in accordance with an embodiment of the present disclosure.

FIG. 29 is a diagrammatic, cross-sectional view of a stack-up of the structures shown in FIG. 28 ready to be welded in accordance with an embodiment of the present disclosure.

FIG. 30 is a diagrammatic, cross-sectional view of a stack-up of structures ready to be welded in accordance with an embodiment of the present disclosure.

FIG. 31 is a diagrammatic, cross-sectional view of a stack-up of structures ready to be welded in accordance with an embodiment of the present disclosure.

FIG. 32 is a perspective view of an assembly of structures joined by electrical resistance welding in accordance with an embodiment of the present disclosure.

FIG. 33 is a diagrammatic, cross-sectional view of a stack-up of structures for forming the assembly of FIG. 32 ready to be welded in accordance with an embodiment of the present disclosure.

FIG. 34 is a diagrammatic, cross-sectional view of a stack-up of structures ready to be welded in accordance with an embodiment of the present disclosure.

FIG. 35 is a diagrammatic, cross-sectional view of a stack-up of structures ready to be welded in accordance with an embodiment of the present disclosure.

FIG. 36 is a perspective view of an assembly of structures joined by electrical resistance welding in accordance with an embodiment of the present disclosure.

FIG. 37 is a perspective view of an assembly of structures joined by electrical resistance welding in accordance with an embodiment of the present disclosure.

FIG. 38 is a diagrammatic, cross-sectional view of a stack-up of the structures of the assembly of FIG. 37 ready to be welded in accordance with an embodiment of the present disclosure.

FIG. 39 is a perspective view of an assembly of structures joined by electrical resistance welding in accordance with an embodiment of the present disclosure.

FIGS. 40 and 41 are exploded and diagrammatic, cross-sectional views of an assembly of structures joined by electrical resistance welding in accordance with an embodiment of the present disclosure.

FIGS. 42 and 43 are side and perspective views, respectively, of an assembly of structures joined by electrical resistance welding in accordance with an embodiment of the present disclosure.

FIGS. 44 and 45 are perspective and diagrammatic, cross-sectional views of an assembly of structures joined by electrical resistance welding in accordance with an embodiment of the present disclosure.

### DETAILED DESCRIPTION OF EXEMPLARY EMBODIMENTS

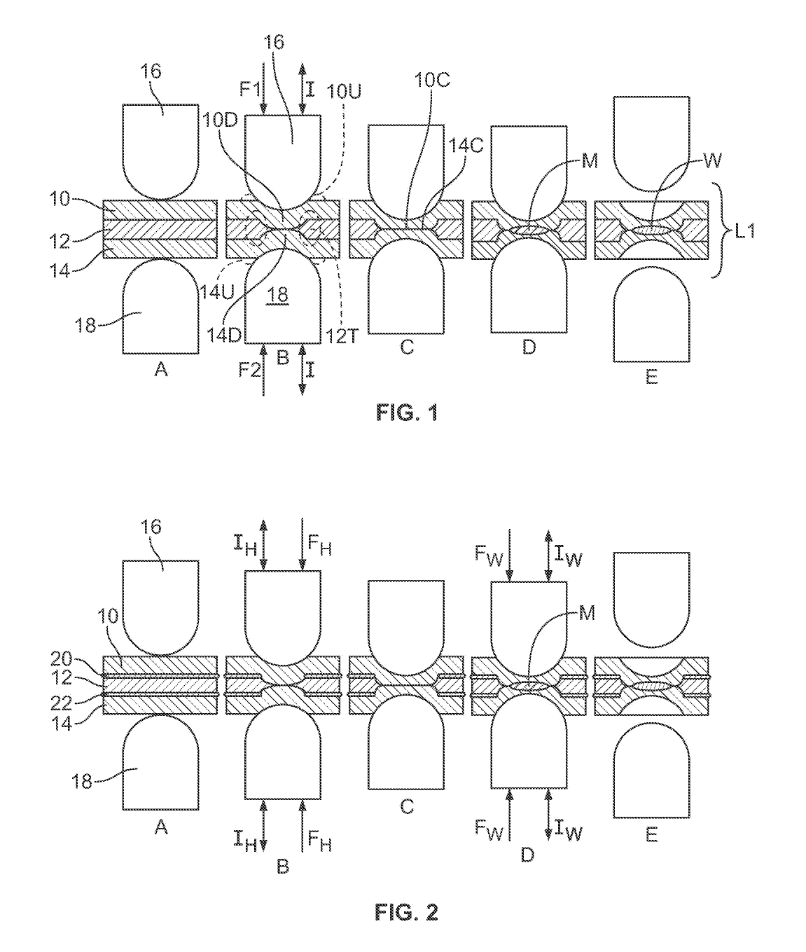

FIG. 1 shows the joining of three layers of material 10, 12, 14 in accordance with an embodiment of the present disclosure. The layers 10, 12, 14 may be dissimilar, e.g., dissimilar metals, like steel and aluminum. For example, the outer layers 10 and 14 may be a steel alloy and the intermediate layer 12 an aluminum alloy. As shown, the two outer layers 10, 14, which are compatible for the purpose of welding, may be welded to one another through the intermediate layer 12, to form a laminate structure L1. This is shown in sequential stages labeled A-E. As shown at stage A, this process may be conducted at a conventional spot welding station having opposing electrodes, the tips 16 and 18 of which are shown at stage A embracing the stack-up of layer 10, 12, 14 before welding. At stage B, opposing forces F1, F2 exerted by the conventional welding machine (not shown) move the tips 16, 18 towards one another, and an electric potential is applied between the electrodes 16, 18 giving rise to a current I passing through the electrodes and layers 10, 12, 14. The forces F1, F2 and current I are applied throughout the stages B-D and the magnitude and duration of each may be varied depending upon the requirements at each stage. For example, the current I required to heat/plasticize the aluminum layer 12 during the transition from stage A to stage C, may be less than that required to weld steel layer 10 to steel layer 14 as occurs during stages C and D. Similarly, the forces F1 and F2 may be varied to accommodate changing processing requirements.

The current I heats each of the layers 10, 12, 14 to a temperature at which the aluminum layer 12 plasticizes and can be displaced/pierced by the upper and lower layers 10, 14 as they are urged toward one another by the electrodes 16, 18. The aluminum layer 12 is heated resistively by current I and also through conduction from the layers 10, 14. The layers 10, 14 have lower heat and electrical conductivity than the aluminum layer 12, such that a low current typically achieved with a resistance spot welder suitable for making resistance spot welds in steel can be used to generate the heat required to plasticize the aluminum layer 12, as well as to weld layer 10 to layer 14, as described below. Since the aluminum alloy layer 12 has a lower melting point than the steel alloy layers 10, 14, the aluminum layer 12 reaches a plastic state permitting displacement by the converging layers 10, 14, which form converging depressions 10D, 14D (U-shaped in cross-section) proximate the electrodes 16, 18 responsive to the forces F1, F2 and current I, allowing the converging layers 10, 14 to penetrate the aluminum layer 12. The convergence of the layers 10, 14, as shown at stage B, results in a displacement of the aluminum alloy of layer 12 at the area of convergence of the layers 10, 14 such that a ring-shaped thickening 12T (shown diagrammatically in dotted lines in stage B only) is formed, causing upwellings 10U and 14U in the softened layers 10, 14 proximate the depressions 10D, 14D. As shown at stages C and D, the layers 10, 14 converge completely, forcing the aluminum alloy of layer 12 out at the surface areas of convergence 10C, 14C, whereupon the layers 10, 14 begin to melt at the area of contact 10C, 14C and a zone M of molten metal begins to form at the interface of the layers 10 and 14. The zone M is the weld material or “nugget” where the metal of the layers 10, 14 liquify and commingle. In accordance with one embodiment, the current I is applied until weld zone M>3*sqrt (minimum gauge of outer layers 10, 14). As shown at stage E, after having accomplished welding at stage D, the forces F1, F2 and current I can be removed and the electrode tips 16 and 18, withdrawn, whereupon the molten zone M hardens to weld W.

As shown in FIG. 2, the foregoing process can be conducted with barrier layers 20, 22, e.g., an adhesive layer of surface pre-treatment or paint/primer (not shown) applied to the upper and lower surfaces of layer 12, or to the surfaces of layer 10, 14 which would otherwise contact layer 12, so long as the barrier layer(s) 20, 22 do not prevent the current I from flowing, impeding electrical resistance heating. In this manner, the contact between joined, dissimilar metals of layers 10, 12, 14 can be reduced, along with unwanted galvanic interaction and corrosion. Since the process of joining in accordance with the present disclosure is attributable to gradual displacement of the layers 10, 12, 14 during the penetration and welding phases B-D, the process accommodates a range of thicknesses of layers 10, 12, 14.

In one example, stages B and C may have an associated force F_{H} of a magnitude of, e.g., from 600 to 2000 pounds and a current level I_{H} of a magnitude of, e.g., from 4,000 to 24,000 amperes, that is appropriate for plasticizing the layer 12 of aluminum having a thickness of 2 mm and welding layer 10 of low-carbon steel with an average thickness of 2.0 mm to layer 14 of 780 MPa galvanized coated steel with a thickness of 1.0 mm. These magnitudes of force and current are just exemplary and are dependent upon the dimensions and compositions of the layers 10, 12, 14. The duration of time to transition from stage B to C may be in the order of 0.2 to 2.0 secs. Pursuing this example further and using the same dimensions and properties of the layers 10, 12, 14, stage D may utilize an associated force F_{W} of a magnitude of, e.g., from 500 to 800 pounds and a current level I_{W} of a magnitude of, e.g., from 6,000 to 18,000 amperes, that is appropriate for initiating the melting of the layers 10, 14 to form a molten weld zone M. The magnitude of force F_{W} may be changed to a force F_{T} (not shown) of a magnitude of, e.g., from 600 to 1,000 pounds and a current level I_{T} (not shown) of a magnitude of, e.g., from 3,000 to 12,000 amperes at stage D to form an expanded weld zone to temper the weld and to render it with an average cross-sectional diameter of 4 mm to 6 mm. The completion of stage D may take, e.g., 0.1 to 0.5 secs.

While the foregoing examples refer to outer layers 10, 14 made from steel, these layers may be from other materials, such as titanium. Similarly, the intermediate layer 12 may be an aluminum alloy or another material, such as a magnesium alloy. In order to penetrate an intervening layer like layer 12, the outer layer 10 and/or 14 should be made of a material with a higher melting point than the intervening layer(s) 12 penetrated during the heating/penetrating phase, e.g., stages B and C (FIG. 1). In order to conduct the welding phase, e.g., stage D, the layers 10, 14 must be compatible to be resistance welded. For example, if the layer 10 is made from high strength (>590 MPa) galvanized steel, then the layer 14 may be made, e.g., from standard, low-carbon steels, high strength steels (>590 MPa) or stainless steel grades.

In one example of a welding operation conducted in accordance with the present disclosure, a commercially available electric spot welding machine, such as a 250 kVA AC resistance spot welding pedestal welding station available from Centerline Welding, Ltd. was employed to conjoin three layers 10, 12, 14, layers 10 and 14 being 0.7 mm 270 MPa galvanized steel and layer 12 being a 1.5 mm 7075-T6 aluminum alloy as shown and described above relative to FIG. 1. The upper electrode tip 16 and the lower electrode tip 18 were standard, commercially available electrodes.

Aspects of the present disclosure include low part distortion, since the layers to be fastened, e.g., 10, 12, 14, are held in compression during the weld and the heat affected zone is primarily restricted to the footprint of the electrodes 16, 18. The conjoined layers 10, 12, 14 trap intermetallics or materials displaced by penetration of the intermediate layer 12.

The weld formed between layers 10 and 14 does not pierce the surface of those layers proximate the weld, preserving appearance, corrosion resistance and water impenetrability. During penetration of layer 12, e.g., at stages B and C of FIG. 1 and the welding phase, stage D, intermetallics are displaced from the weld zone M. The methodology and apparatus of the present disclosure is compatible with conventional RSW equipment developed for steel sheet resistance welding. The layers 10, 14 may optionally be coated (galvanized, galvaneal, hot-dipped, aluminized) to improve corrosion resistance.

The welding process of the present disclosure does not require a pilot hole, but can also be used with a pilot hole in the intermediate layer 12. Pilot holes may also be used to allow electrical flow through dielectric layers such as adhesive layers or anti-corrosive coatings/layers 20, 22. The weld quality resulting from use of the process can be tested in accordance with quality assurance measurements applied to the cavity left by the weld, i.e., by measuring the dimensions of the cavity. Ultrasonic NDE techniques may also be utilized on the side(s), e.g., of layers 10 14 to monitor the weld quality.

Compared to FDS (EJOTS), SPR, and SFJ, the apparatus of the present disclosure used to fasten layers of dissimilar materials has a smaller footprint, allowing access to tighter spaces. The apparatus and method of the present disclosure uses lower compressive forces as compared to SPR insertion forces since the layers 10, 12, 14 are heated/softened during stages B-D of FIG. 1. The methods and apparatus of the present disclosure provide the ability to join high strength aluminums (which are sensitive to cracking during SPR operations) and to join high and ultra high strength steels, since there is no need to pierce the steel metal with the fastener but rather, spot welding is employed.

The apparatus and method of the present disclosure does not require rotating parts and is conducive to resolving part fit-up issues since the overall process is similar to conventional resistance spot welding (RSW) with respect to how the component layers/parts are fixtured. In addition, the process can be conducted quickly, providing fast processing speeds similar to conventional RSW. The apparatus and methods of the present disclosure can be applied to use on both wrought and cast aluminum products and may be used to produce a compatible metal joint rather than a bimetallic weld, as when welding aluminum to steel, which may have low joint strength. As noted below, the apparatus and methods of the present disclosure may be used to conjoin multiple layers of different materials.

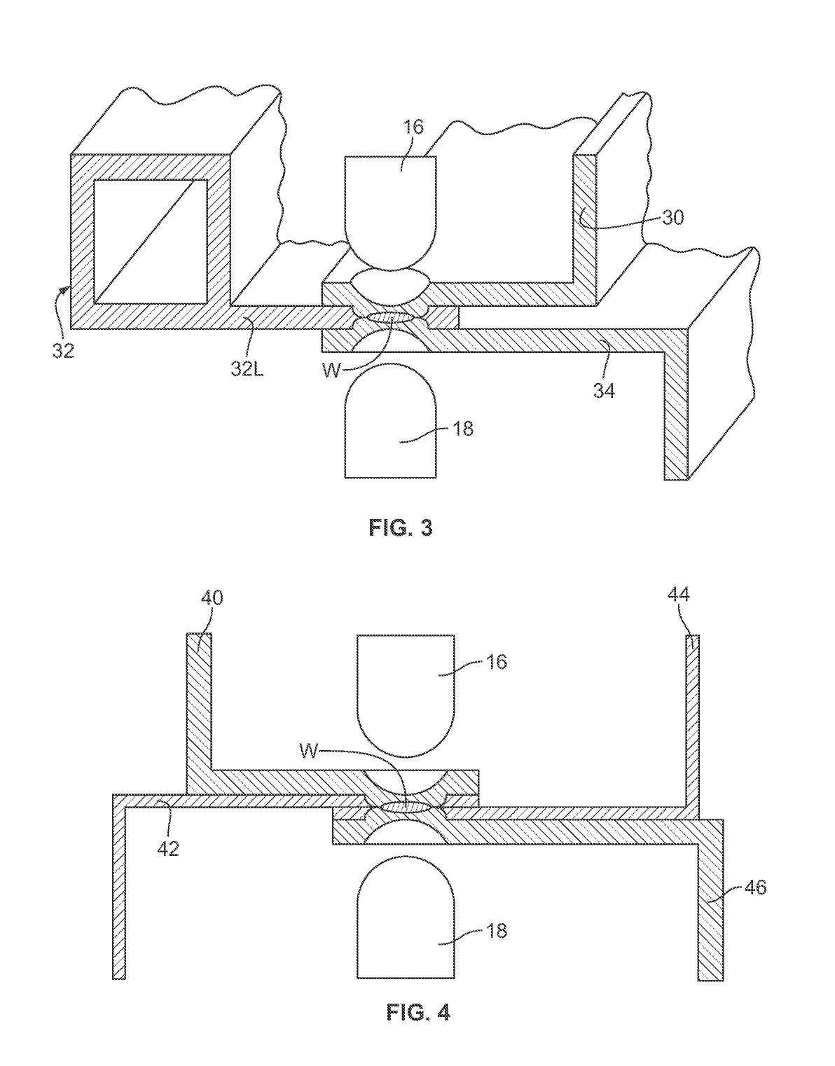

FIG. 3 shows that the process of the present disclosure may be used to join three structures 30, 32, 34 by electrical resistance welding applied by electrodes 16, 18 that function as described above in reference to FIG. 1. In this instance, structure 32 may be a box-shaped hollow beam, e.g., made from aluminum alloy with a leg 32L that is captured between the L-shaped structures 30, 34. The structure 32 may be fabricated, cast, forged or extruded. Multiple welds W may be made along the length of the structures 30, 32, 34, as required for the application. The structures 30, 32, 34 are shown in cross section and in three dimensions in FIG. 3. Figures described below, may show the cross-sectional view only for simplicity of illustration.

FIG. 4 shows that the process of the present disclosure may be used to join four structures 40, 42, 44, 46, by electrical resistance welding applied by electrodes 16, 18 that function as described above in reference to FIG. 1. In this instance, two L-shaped intermediate structures 42, 44, e.g., made from aluminum alloy are captured between two L-shaped structures 40, 46, e.g., made from steel and conjoined at weld W. When mentioned herein, “steels” shall include various types of steel, including stainless steels and titanium alloys. “Aluminum alloys” shall include magnesium alloys.

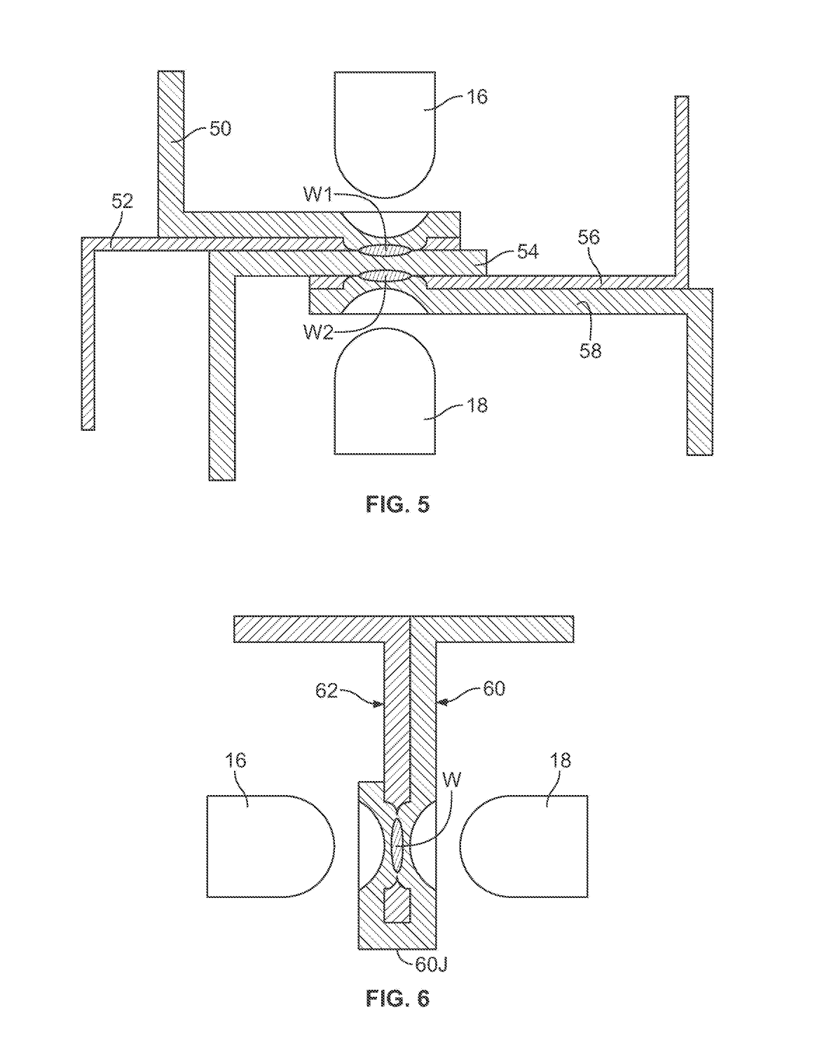

FIG. 5 shows that the process of the present disclosure may be used to join five structures 50, 52, 54, 56, 58 by electrical resistance welding applied by electrodes 16, 18 that function as described above in reference to FIG. 1. In this instance, two L-shaped intermediate structures 52, 56, e.g., made from aluminum alloy are captured between three L-shaped structures 50, 54, 58 e.g., made from steels, etc. Weld W1 joins structure 50 to structure 54 and weld W2 joins structure 54 to structure 58 capturing structures 52 and 56 there between, respectively.

FIG. 6 shows that the process of the present disclosure may be used to join two structures 60, 62 by electrical resistance welding applied by electrodes 16, 18 that function as described above in reference to FIG. 1. In this instance, an L-shaped intermediate structure 62, e.g., made from aluminum alloy is captured in a “J” portion 60J of structure 60, e.g., made from steel, and retained there by electrical resistance welding in accordance with an embodiment of the present disclosure. In this instance, the weld W is established between the opposing portions of the “J” portion 60J.

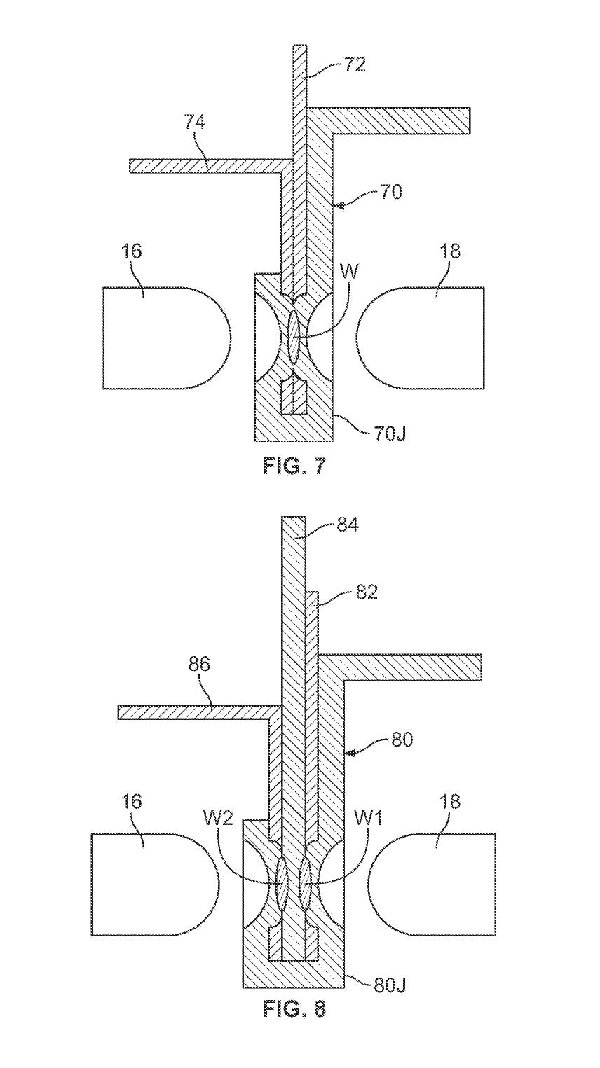

FIG. 7 shows that the process of the present disclosure may be used to join three structures 70, 72, 74 by electrical resistance welding applied by electrodes 16, 18 that function as described above in reference to FIG. 1. In this instance, two intermediate structures 72, 74, e.g., made from aluminum alloy, are captured in a “J” portion 70J of structure 70, e.g., made from steel and retained there by electrical resistance welding in accordance with an embodiment of the present disclosure. The weld W is established between the opposing portions of the “J” portion 70J.

FIG. 8 shows that the process of the present disclosure may be used to join four structures 80, 82, 84, 86 by electrical resistance welding applied by electrodes 16, 18 that function as described above in reference to FIG. 1. In this instance, two intermediate structures 82, 86, e.g., made from aluminum alloy are captured along with structure 84 (steel) in a “J” portion 80J of structure 80, e.g., made from steel and retained there by electrical resistance welding in accordance with an embodiment of the present disclosure. In this instance, weld W1 is established between intermediate steel structure 84 and structure 80 and weld W2 is established between another side of intermediate structure 84 and J-shaped portion 80J of structure 80.

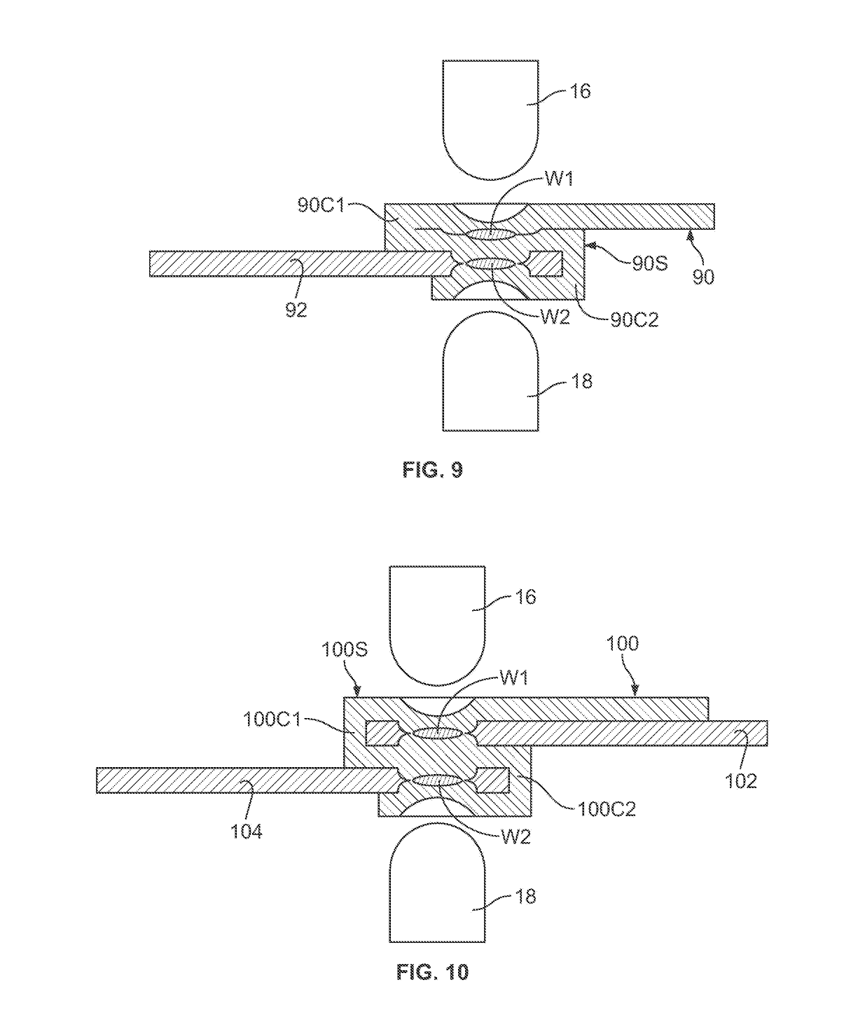

FIG. 9 shows that the process of the present disclosure may be used to join two structures 90, 92 by electrical resistance welding applied by electrodes 16, 18 that function as described above in reference to FIG. 1. In this instance, an intermediate structure 92, e.g., made from aluminum alloy is captured in the bottom curve 90C2 of an S-shaped portion 90S of structure 90, e.g., made from steel, and retained there by electrical resistance welding in accordance with an embodiment of the present disclosure. In this instance, weld W1 is established between the opposing portions of curve 90C 1 of the structure 90 and weld W2 is established between the opposing portions of curve 90C2 of the structure 90, capturing structure 92 therein.

FIG. 10 is a diagrammatic, cross-sectional view showing the joining of three structures, 100, 102, 104, structure 100 having an “S” configuration, by electrical resistance welding in accordance with an embodiment of the present disclosure. An intermediate structure 102, e.g., made from aluminum alloy is captured in the top curve 100C1 of an S-shaped portion 100S of structure 100, e.g., made from steel. Intermediate structure 104, e.g., made from aluminum alloy, is captured in the bottom curve 100C2 of an S-shaped portion 100S of structure 100. Both structure 102 and 104 are retained in S-shaped portion 100S by electrical resistance welding in accordance with an embodiment of the present disclosure. Weld W1 is established between the opposing portions of curve 100C1 and weld W2 is established between the opposing portions of curve 100C2 of the structure 100.

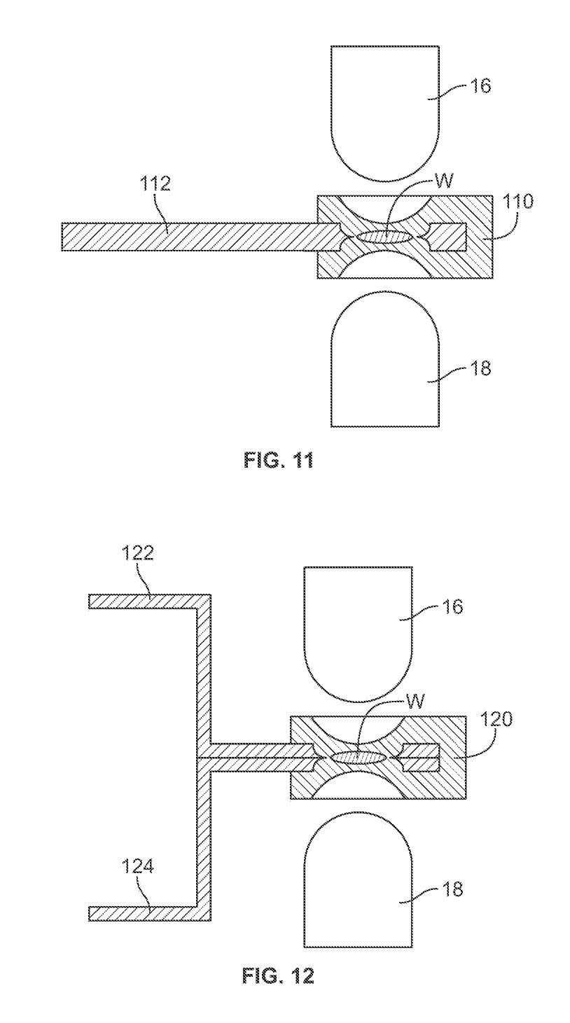

FIG. 11 shows that the process of the present disclosure may be used to join two structures 110, 112 by electrical resistance welding applied by electrodes 16, 18 that function as described above in reference to FIG. 1. In this instance, an intermediate structure 112, e.g., made from aluminum alloy is captured in a U-shaped structure 110, e.g., made from steel and retained there by electrical resistance welding in accordance with an embodiment of the present disclosure. In this instance, the weld W is established between the opposing portions of the U-shaped structure 110.

FIG. 12 shows that the process of the present disclosure may be used to join three structures 120, 122, 124 by electrical resistance welding applied by electrodes 16, 18 that function as described above in reference to FIG. 1. The intermediate structures 122, 124, e.g., made from aluminum alloy are captured in a U-shaped structure 120, e.g., made from steel and retained there by electrical resistance welding in accordance with an embodiment of the present disclosure. The weld W is established between the opposing portions of the U-shaped structure 120.

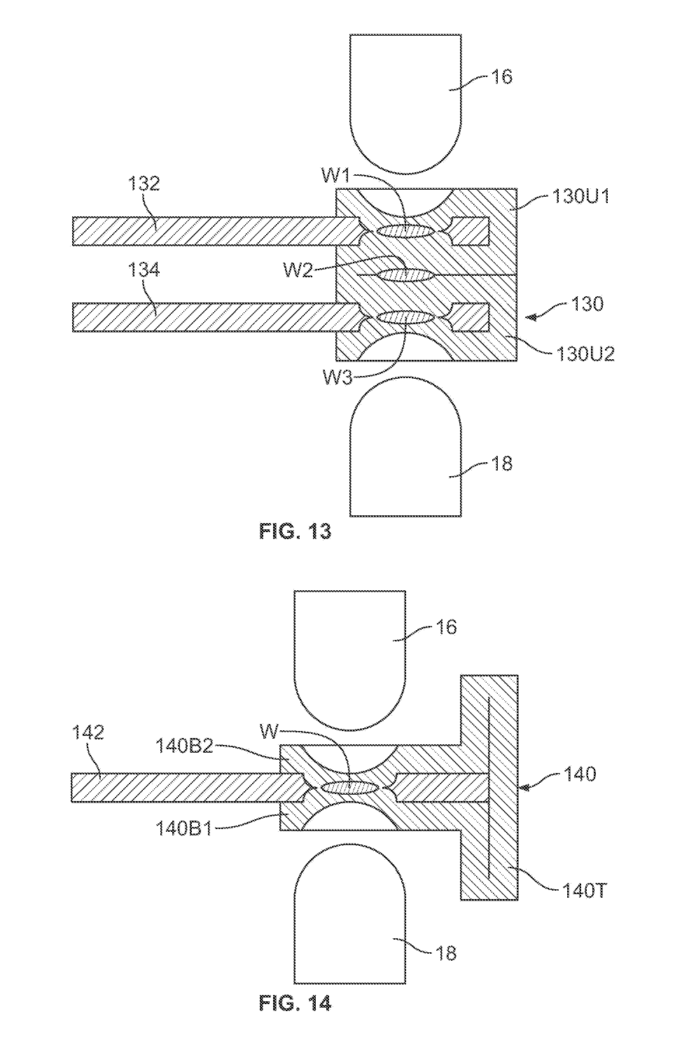

FIG. 13 shows that the process of the present disclosure may be used to join three structures 130, 132, 134 by electrical resistance welding applied by electrodes 16, 18 that function as described above in reference to FIG. 1. The intermediate structures 132, 134, e.g., made from aluminum alloy, are captured in the U-shaped structures 130U1 and 130U2 which make up the W-shaped structure 130, e.g., made from steel and retained there by electrical resistance welding in accordance with an embodiment of the present disclosure. The welds W1, W2 and W3 are established between the opposing portions of the U-shaped structures 130U1 and 130U2 which make up the W-shaped structure 130.

FIG. 14 shows that the process of the present disclosure may be used to join two structures 140, 142 by electrical resistance welding applied by electrodes 16, 18 that function as described above in reference to FIG. 1. In this instance, an intermediate structure 142, e.g., made from aluminum alloy is captured in a split T-shaped structure 140, e.g., made from steel and retained there by electrical resistance welding in accordance with an embodiment of the present disclosure. In this instance, the weld W is established between the opposing bottom portions 140B1 and 140B2 of the T-shaped structure 140.

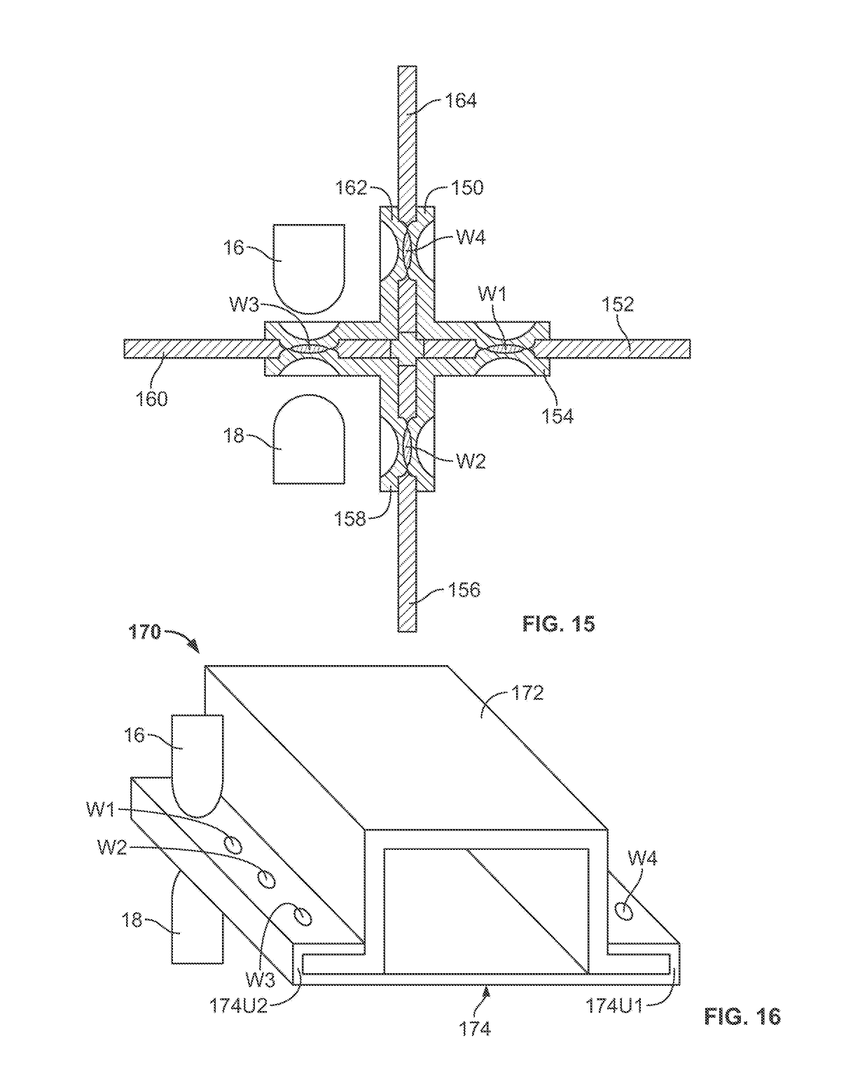

FIG. 15 shows that the process of the present disclosure may be used to join eight structures 150, 152, 154, 156, 158, 160, 162, 164 by electrical resistance welding applied by electrodes 16, 18 that function as described above in reference to FIG. 1. Intermediate structures 152, 156, 160 and 164, e.g., made from aluminum alloy are captured between four L-shaped structures 150, 154, 158 and 162, e.g., made from steel and retained there by electrical resistance welding in accordance with an embodiment of the present disclosure. The welds W1, W2, W3 and W4 are established between the opposing L-shaped structures 150, 154, 158 and 162.

FIG. 16 shows a composite beam 170 formed from mating structures 172, e.g., made from aluminum, and structure 174 made from steel, joined by electrical resistance welding applied by electrodes 16, 18 that function as described above in reference to FIG. 1. A series of welds, W1, W2, W3, W4, etc., along the U-shaped portions 174U1 and 174U2, retain the structure 170 together.

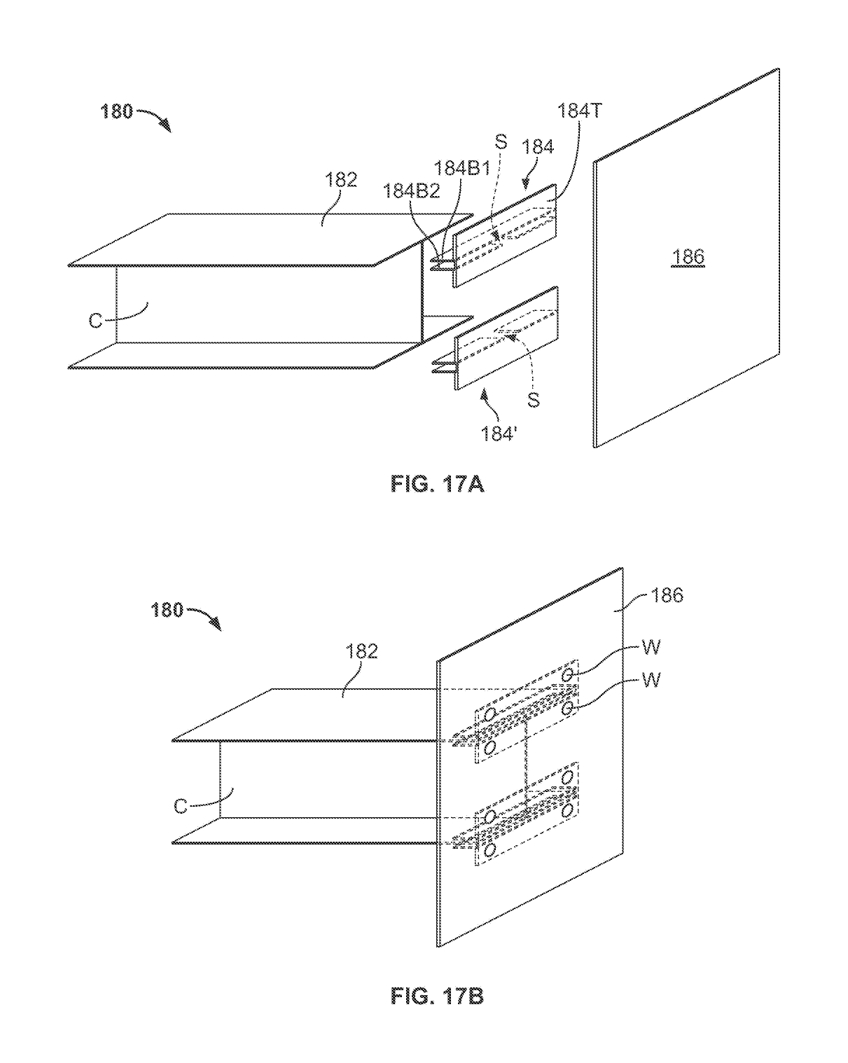

FIGS. 17a and 17b show composite beam 180 formed from mating structures 182, e.g., made from aluminum and T-shaped structures 184, 184′ made from steel, joined by electrical resistance welding applied by electrodes 16, 18 (not shown) that function as described above in reference to FIG. 1. As in described in relation to FIG. 14, spot welds of portions 184B1 and 184B2 extending through the structure 182 may be used to secure structures 184 to the I-beam structure 182. The same approach is applicable to structure 184′. Slots S accommodate the center web C of the I beam structure 182. The upper portions, e.g., 184T, may be used as mounting flanges to spot weld a plate 186, e.g., made from steel, as shown by welds W in FIG. 17b.

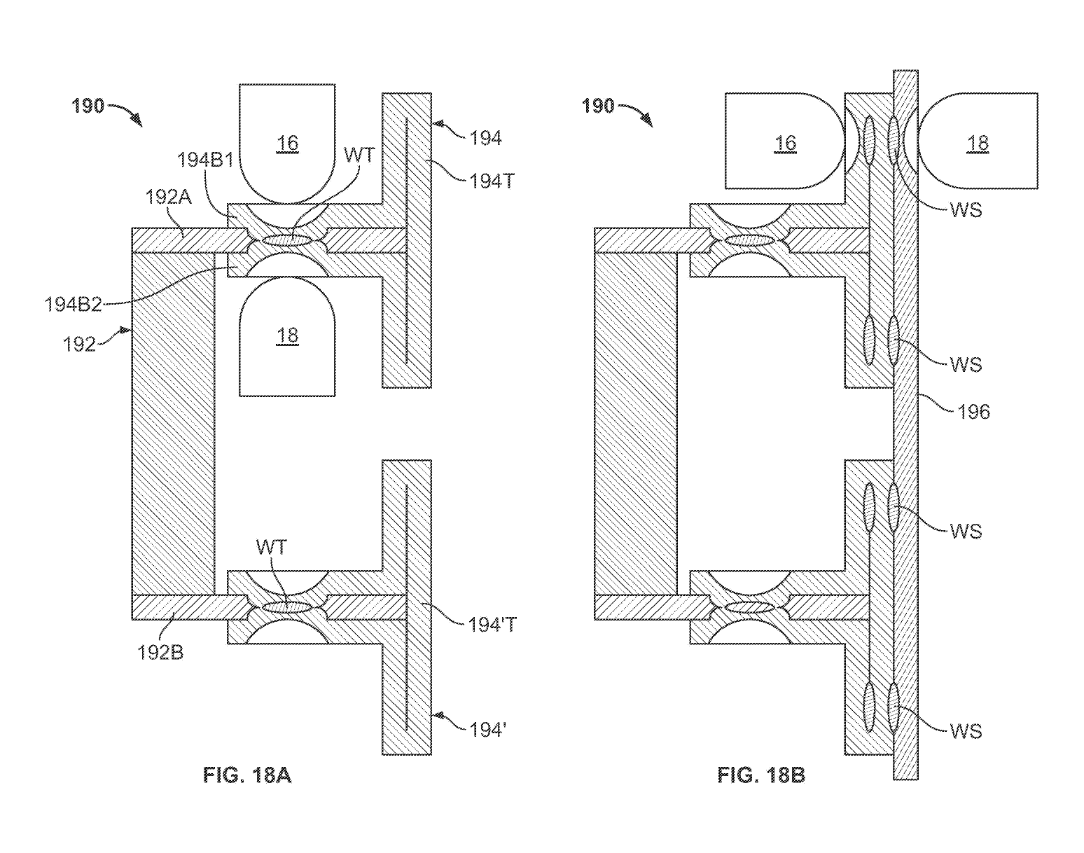

FIGS. 18a and 18b show a composite structure 190 with a similar makeup as structure 180 shown in FIGS. 17a, 17b, with structure 190 formed from mating structures 192, e.g., made from aluminum and T-shaped structures 194, 194′ made from steel, joined by electrical resistance welding applied by electrodes 16, 18 that function as described above in reference to FIG. 1. Spot welds WT of portions 194B1 and 194B2 extend through the extension 192A (with a similar arrangement applying to 194′) and 192B to secure structures 194, 194′ to the structure 192. The upper portions 194T 194′T may be used as mounting flanges to spot weld a plate 196, e.g., made from steel, as shown by welds WS in FIG. 18b.

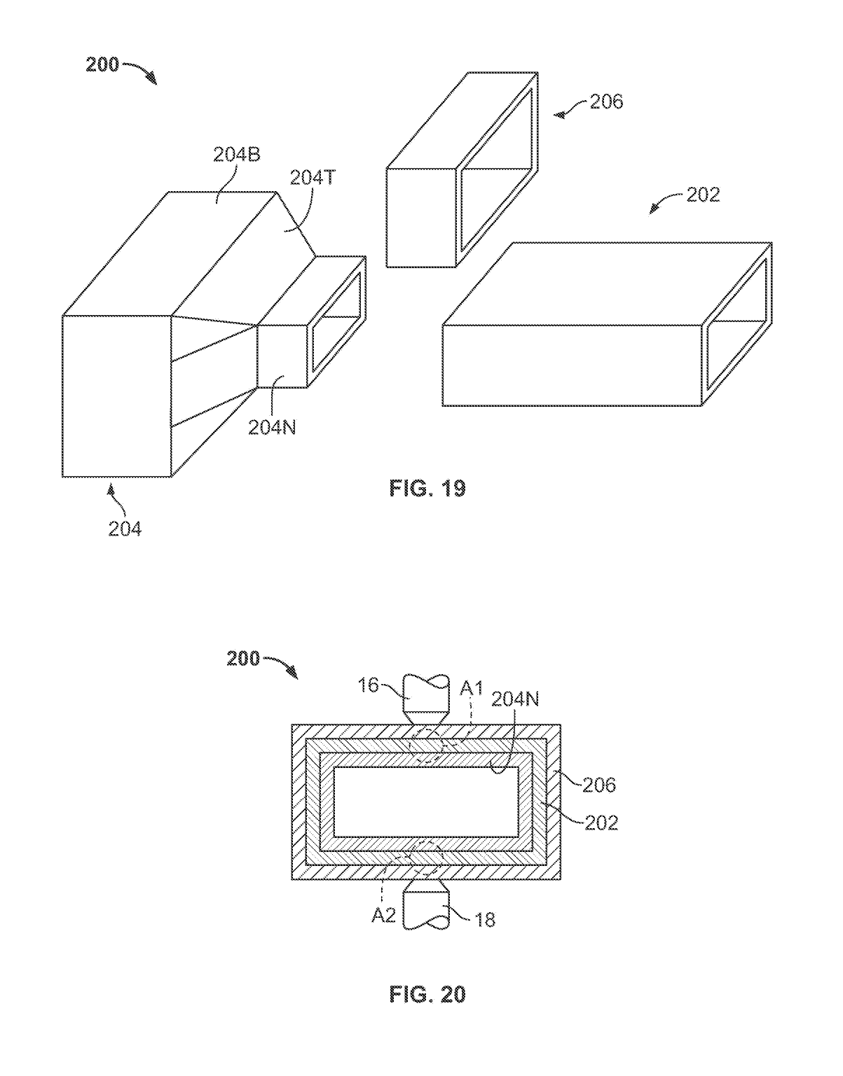

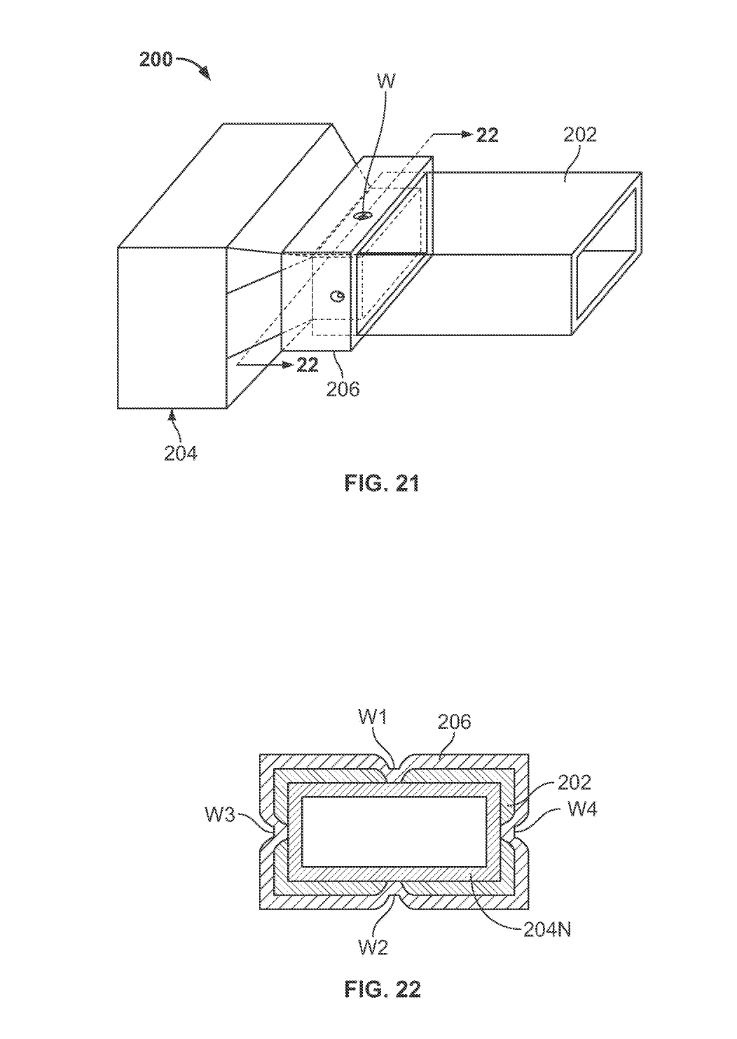

FIGS. 19-22 show a composite structure 200 formed from a hollow beam structure 202, e.g., made from aluminum, a tapered tubular structure 204 made, e.g., from fabricated or cast steel and a collar structure 206, e.g., made from steel, joined by electrical resistance welding applied by electrodes 16, 18 that function as described above in reference to FIG. 1. The structure 204 has a base portion 204B, a tapered portion 204T and a nipple portion 204N that slideably receives the hollow beam structure 202 there over. The collar structure 206 is slideably received over the structure 202. Spot welds W extend through the hollow beam structure 202 to join the collar structure 206 to the nipple portion 204N to secure the assembly 200 together by electrical resistance welding. The welds W could be described as rivets, which rivet the collar structure 206 and the beam structure 202 to the nipple portion 204N. As shown in FIG. 20, this welding/riveting operation can be conducted by a single weld gun with electrodes 16, 18 positioned on opposite sides of the structure 200 to simultaneously conduct welding in the areas A1 and A2, resulting in welds W1, W2, as shown in FIG. 22. The welds W3, W4 could likewise be simultaneously conducted, the simultaneous generation of multiple welds reducing the total number of repositioning operations of the workpiece/welding apparatus required to complete the welding/riveting operation.

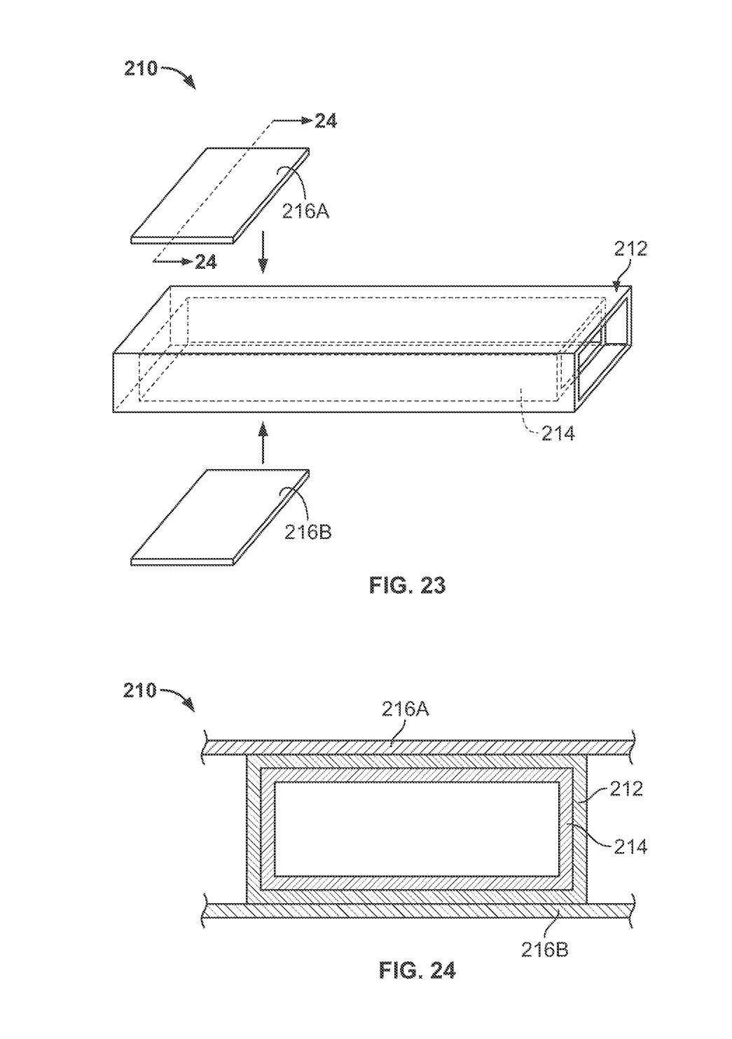

FIGS. 23 and 24 show a composite structure 210 formed from a hollow beam structure 212, e.g., made from aluminum, a tubular structure 214 made from steel and plates 216A, 216B, e.g., made from steel, joined by electrical resistance welding applied by electrodes 16, 18 that function as described above in reference to FIG. 1. The structure 214 may have any given length relative to structure 212, but in the embodiment depicted should have overlap with the plates 216A, 216B in order to permit spot welding the plates to the structure 214, which may be slideably received within structure 212. The resulting composite 210 has properties attributable to each of the structures 212, 214 and 216A, 216B. In one alternative, the tubular structure 214 may be subdivided into a plurality of separate tubular structures, e.g., a first disposed in the hollow beam 212 proximate one end and the other disposed at the other end or in an intermediate position, allowing additional plate(s) 216 to be attached at the other end or in an intermediate position(s).

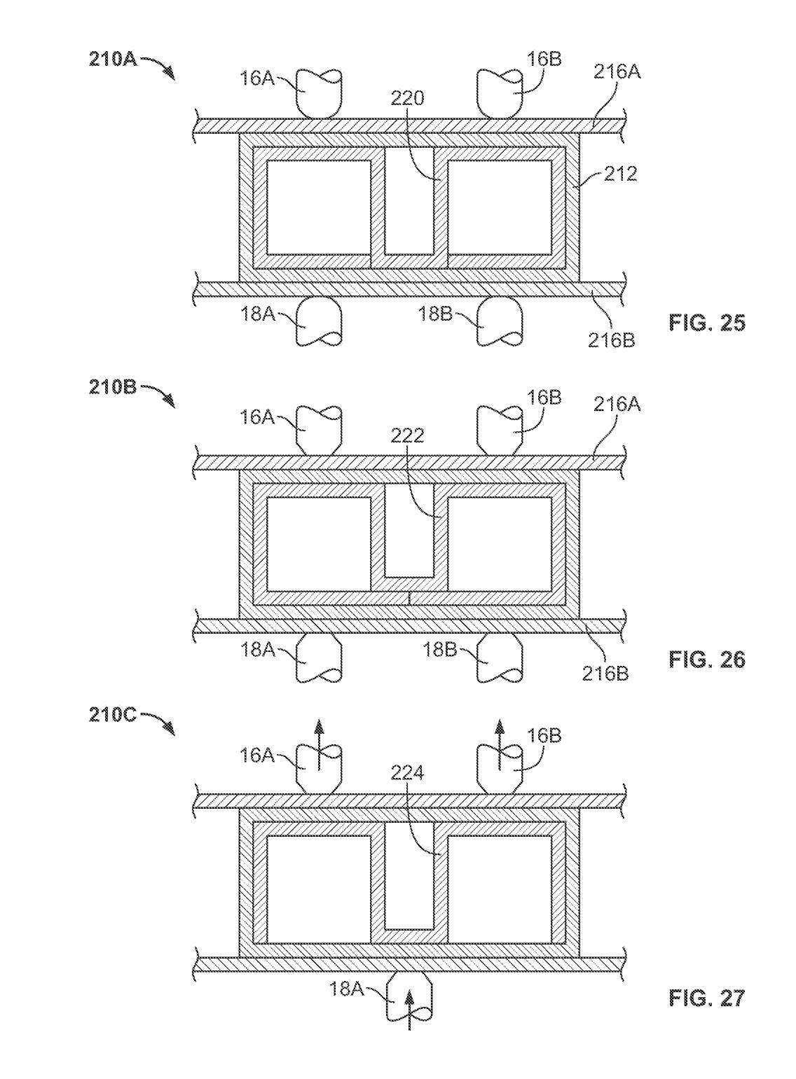

FIGS. 25-27 show variations 210A, 210B, 210C on the composite structure 210 shown in FIGS. 23 and 24. More particularly, the internal structures 220 (FIG. 25), 222 (FIG. 26), 224 (FIG. 27), show three different cross-sectional shapes. FIGS. 25 and 26 show a welding stack-up arrangement for direct welding, wherein the current passes between 16A and 18A and 16B and 18B, respectively. The welding may be of the push-pull type, permitting four welds to be conducted simultaneously. Note that for simplicity of illustration, the areas where welding would be conducted are not shown in FIG. 25 and the figures following FIG. 25, but such areas are like the areas A1, A2 of FIG. 20, which are proximate the electrodes 16, 18 and in FIG. 25-27 would be proximate the electrodes 16A, 16B, 18A, 18B. FIG. 27 shows an alternative electrode arrangement wherein electrodes 16A and 16B define a current path including a single electrode 18A on the other side of the stack-up 210C. Alternatively, the hollow beam (tube) structure 212 may be formed from a sheet wrapped around the internal structures 220, 222, 224.

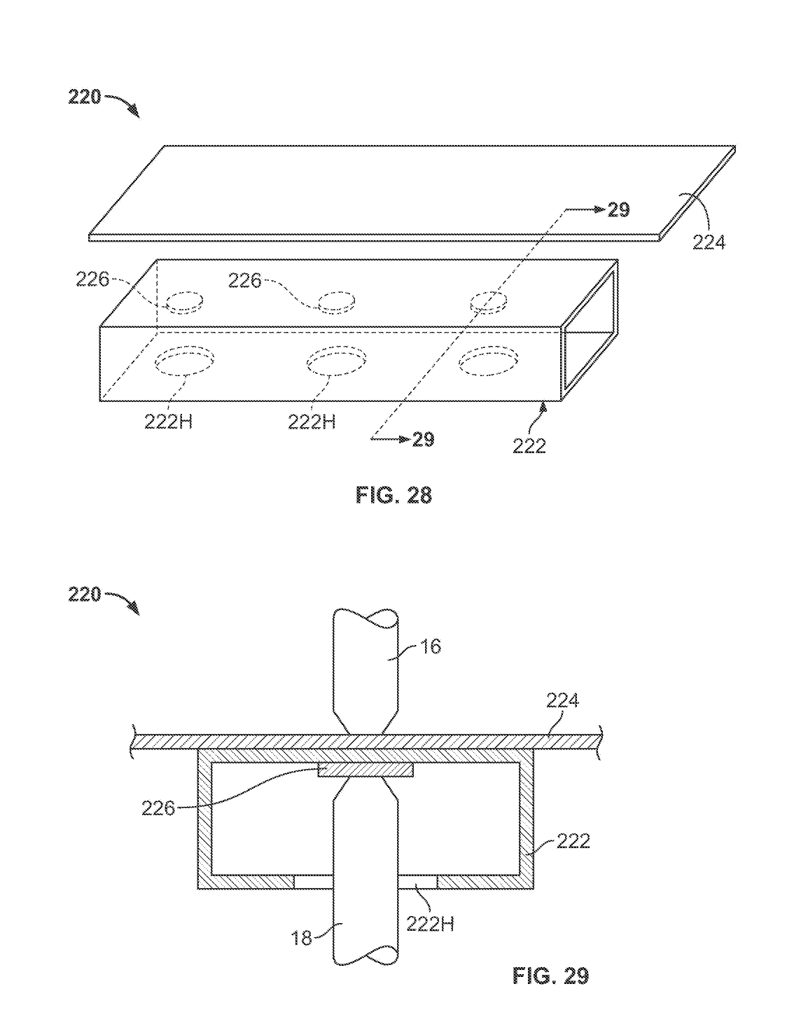

FIGS. 28 and 29 show composite structure 220 formed from a hollow beam structure 222, e.g., made from aluminum, a plate 224 and a plurality of disks 226, e.g., made from steel, joined by electrical resistance welding applied by electrodes 16, 18 that function as described above in reference to FIG. 1. The hollow beam structure 222 has a plurality of openings 222H through which the disks 226 may be inserted and accessed by an electrode 18 in order to permit spot welding the disks 226 to the plate 224 through the beam structure 222.

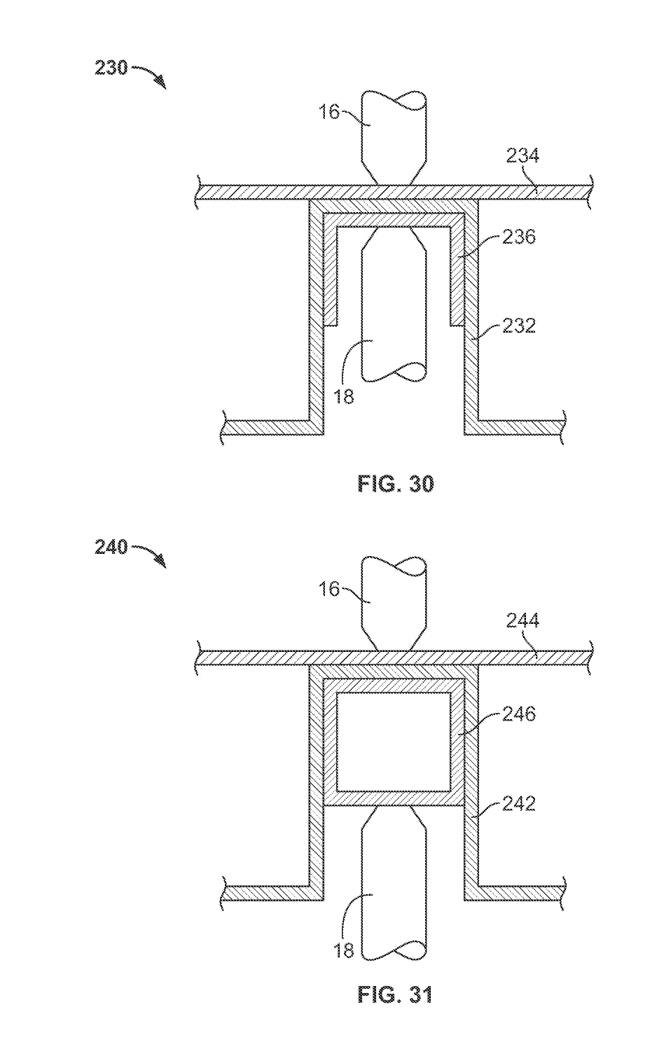

FIG. 30 shows a stack-up for a composite structure 230 formed from a hollow beam structure 232, e.g., made from aluminum, a plate 234 and a U-shaped member (channel) 236, e.g., made from steel, that may be joined by electrical resistance welding applied by electrodes 16, 18 that function as described above in reference to FIG. 1. The U-shaped member 236 may be spring loaded, i.e., the U-shape may be biased to diverge outwardly and may frictionally grip hollow beam structure 232. The U-shaped member 236 may be inserted into hollow beam structure 232 by electro-magnetic forming, shrink-fit, mechanical contact, bonding, fastening, clinching, brazing, etc.

FIG. 31 shows a stack-up for a composite structure 240 formed from a hollow beam structure 242, e.g., made from aluminum, a plate 244 and a hollow beam (tube) 246, e.g., made from steel, that may be joined by electrical resistance welding applied by electrodes 16, 18 that function as described above in reference to FIG. 1. The hollow beam 246 may be inserted into hollow beam structure 242 by electro-magnetic forming, shrink-fit, mechanical contact, bonding, fastening, clinching, brazing, etc.

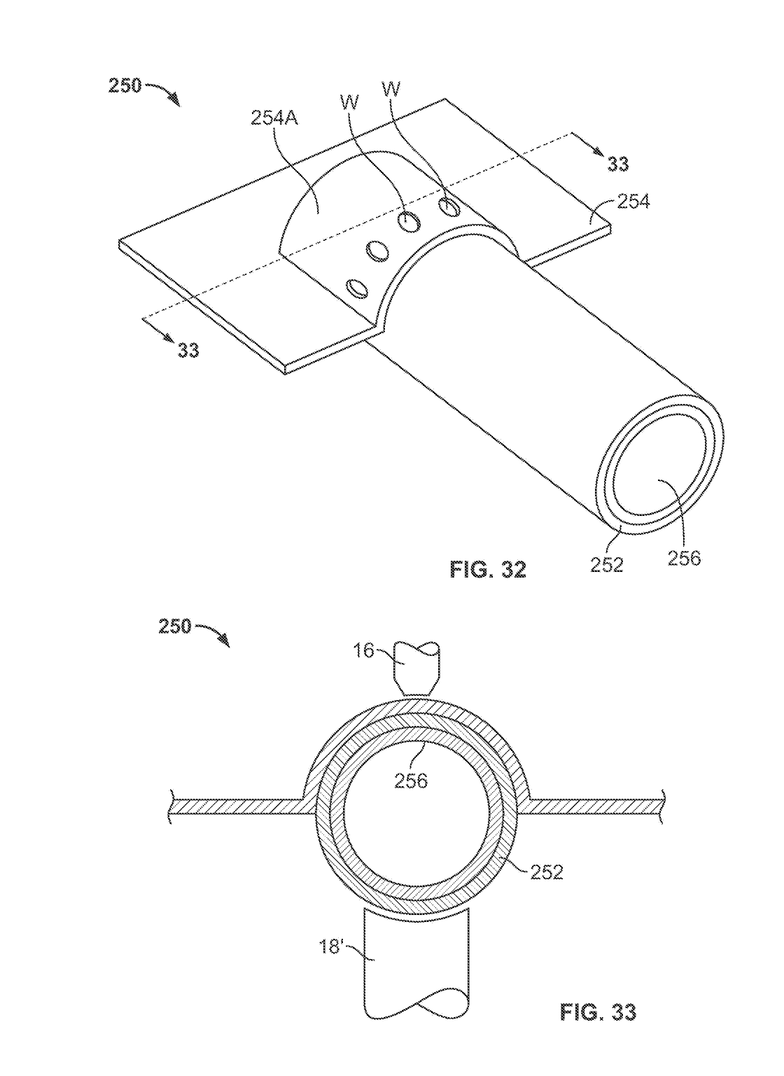

FIGS. 32 and 33 show composite structure 250 formed from a hollow, cylindrical beam structure 252, e.g., made from aluminum, a plate 254 and a hollow cylindrical support beam 256, e.g., made from steel, joined by electrical resistance welding applied by electrodes 16, 18′ that function as described above in reference to FIG. 1. The plate 254 has an arch portion 254A that is complementarily shaped relative to the beam structure 252. A plurality of welds W secure the plate 254 to the support beam 256. FIG. 33 shows the welding stackup of composite structure 250. As can be seen, the electrode 18′ has a large surface area such that the electric current and heat attributable to resistive flow is distributed and does not cause melting to occur at the interface with the beam structure 252. Electrode 16 has a normal spot welding configuration, such that it concentrates the current and heat to form a spot weld W.

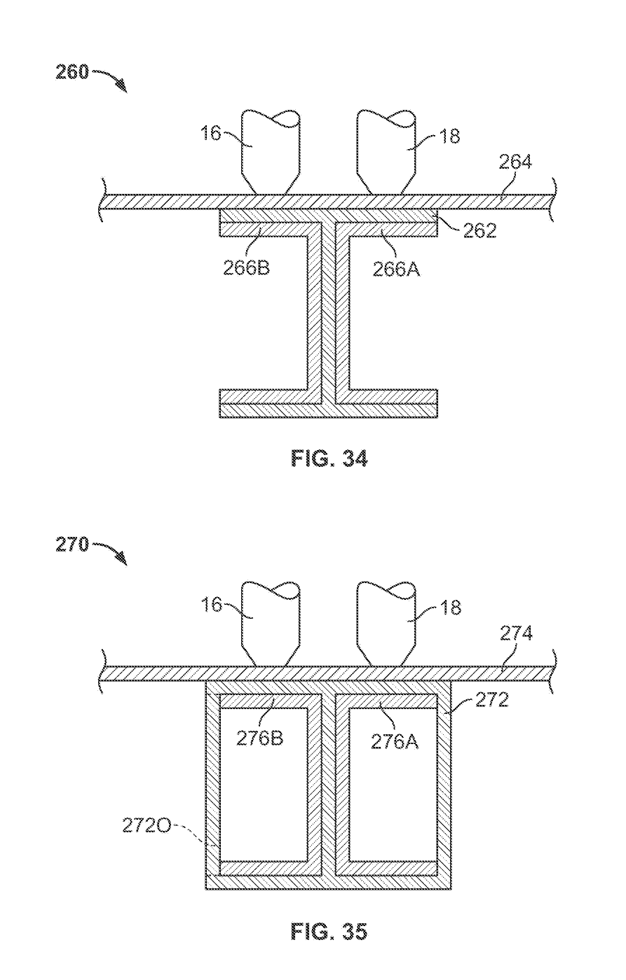

FIG. 34 shows a stack-up for a composite structure 260 formed from an I beam structure 262, e.g., made from aluminum, a plate 264 and a pair of channel beams 266A, 266B, e.g., made from steel, that may be joined to the plate 264 by electrical resistance welding applied by electrodes 16, 18 that function as described above in reference to FIG. 1. Since both electrodes 16, 18 are on the same side of plate 264, the welding set-up could be described as for single sided welding.

FIG. 35 shows a stack-up for a composite structure 270 formed from a boxed I beam structure 272, e.g., made from aluminum, a plate 274 and a pair of channel beams 276A, 276B, e.g., made from steel, that may be joined to the plate 274 by electrical resistance welding applied by electrodes 16, 18 that function as described above in reference to FIG. 1. Since both electrodes 16, 18 are on the same side of plate 274, the welding set-up could be described as for single sided welding. The channel beams 276A, 276B may be inserted in the beam structure 272 telescopically at an end, or openings 272O may be provided in the beam structure 272 to allow insertion of the channel beams, e.g., 276B.

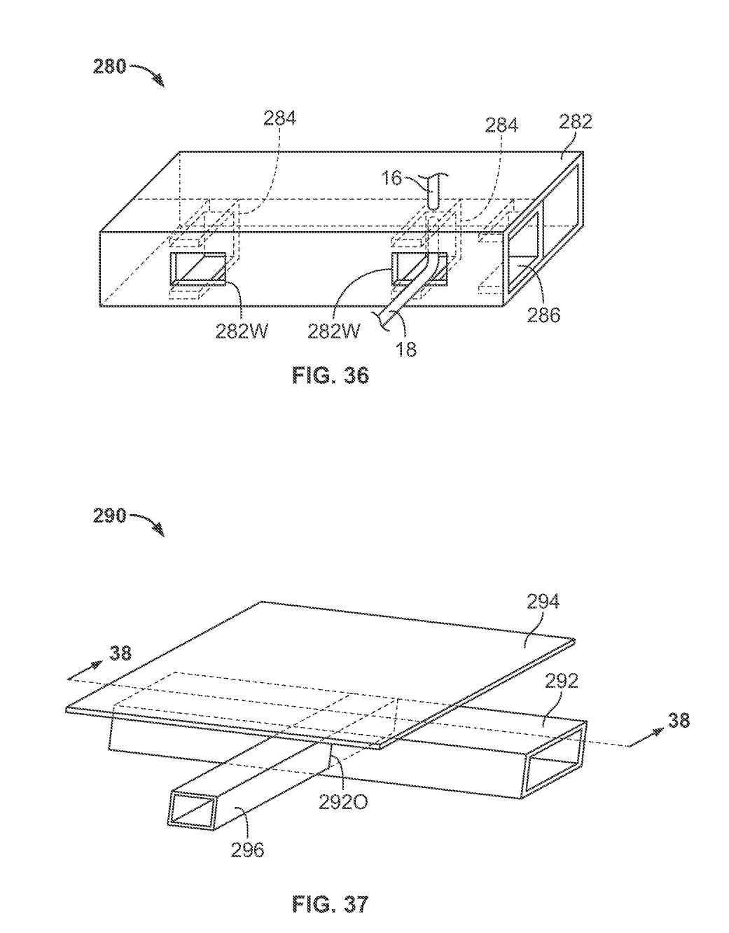

FIG. 36 shows a composite structure 280 formed from a hollow beam structure 282, e.g., made from aluminum with access windows 282W through which brackets 284, e.g., made from steel, may be inserted and through which electrode 18 may be inserted to perform a spot welding operation as described above for securing a plate or other steel member (not shown) placed against the outer surface of the beam structure 282 in proximity to the brackets 284. An alternative type of bracket 286 is shown positioned at the open end of the beam 282 and may perform a similar function as brackets 284.

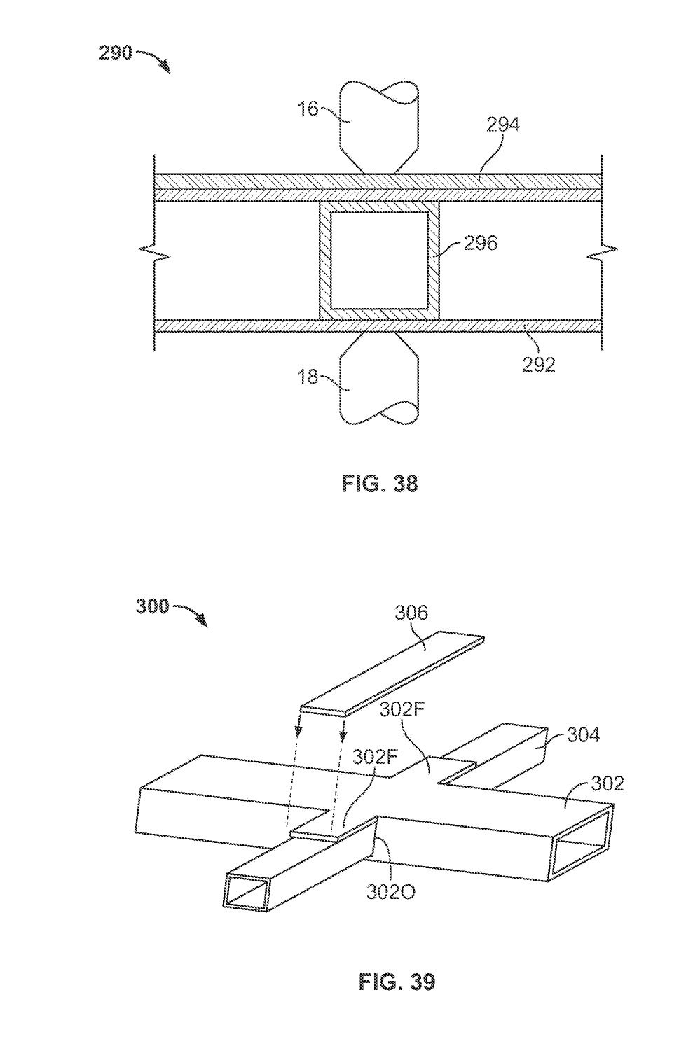

FIGS. 37 and 38 show composite structure 290 formed from a hollow beam structure 292, e.g., made from aluminum, a plate 294 and a hollow beam structure 296, e.g., made from steel, joined by electrical resistance welding applied by electrodes 16, 18 that function as described above in reference to FIG. 1. The beam structure 292 has an opening 292O permitting the perpendicular insertion of beam structure 296. As shown in the welding stack-up of FIG. 38, the electrodes 16, 18 may be utilized to weld plate 294 through beam 292 to beam 296.

FIG. 39 shows a composite structure 300 formed from a hollow beam structure 302, e.g., made from aluminum, a hollow beam structure 304 and a plate 306, e.g., made from steel, joined by electrical resistance welding applied by electrodes 16, 18 that function as described above in reference to FIG. 1. The beam structure 302 has side openings 302O permitting the perpendicular insertion of beam structure 304. The beam structure 302 has flanges 302F extending from the beam 302 proximate the openings 302O. The plate 306 may be welded through beam 302 and/or flanges 302F to beam 304.

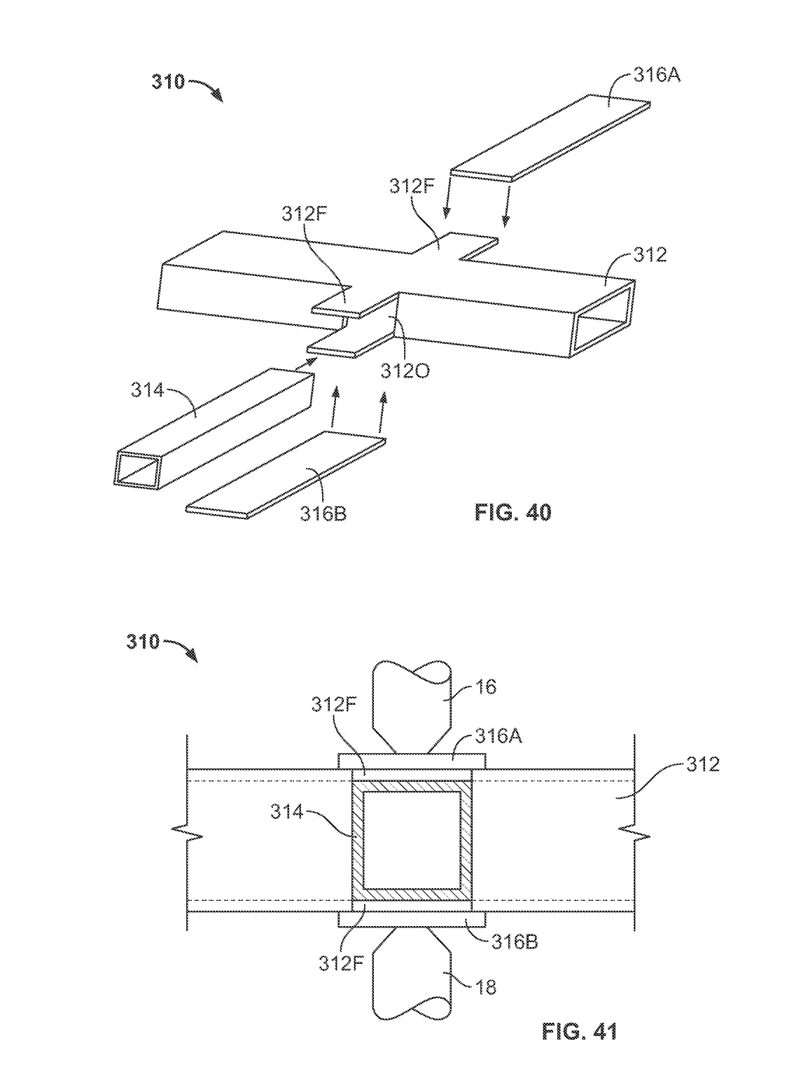

FIGS. 40 and 41 show a composite structure 310 formed from a hollow beam structure 312, e.g., made from aluminum, a hollow beam structure 314 and plates 316A, 316B, e.g., made from steel, joined by electrical resistance welding applied by electrodes 16, 18 that function as described above in reference to FIG. 1. The beam structure 312 has side openings 312O permitting the perpendicular insertion of beam structure 314. The beam structure 312 has flanges 312F (four in number) extending from the beam 312 proximate the openings 312O. The plates 316A, 316B may be welded through beam 312 and/or flanges 312F to beam 314. FIG. 41 shows the welding stack-up of components of structure 310 prior to welding.

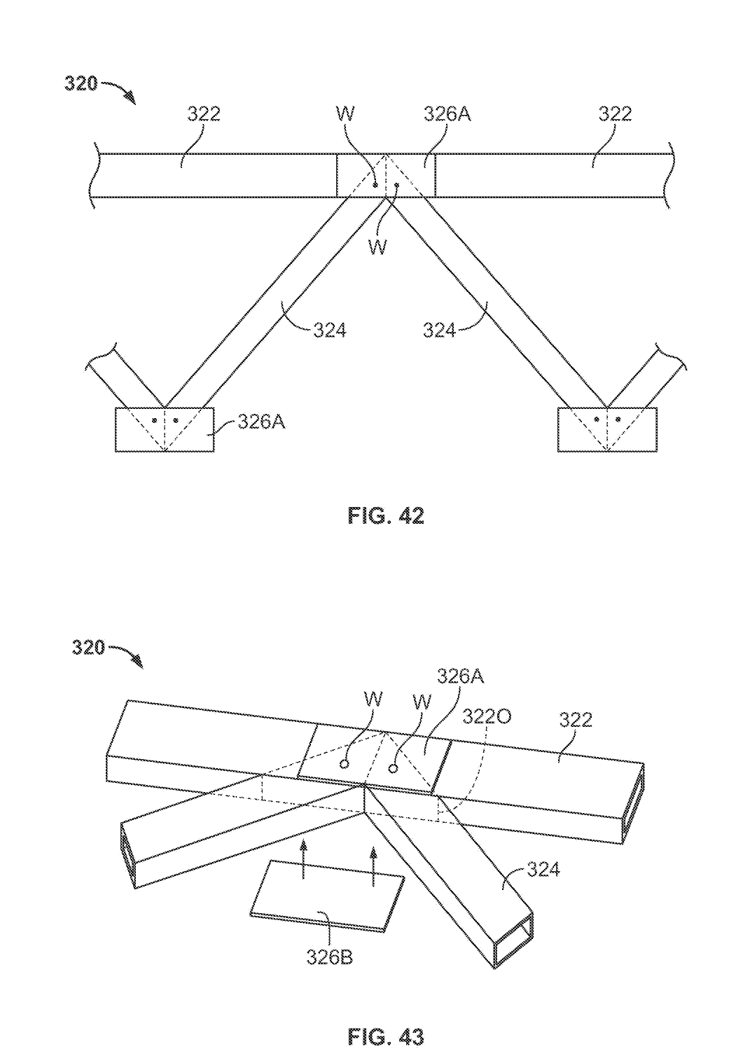

FIGS. 42 and 43 show a composite truss structure 320 formed from hollow beam structures 322, e.g., made from aluminum, hollow beam structures 324 and plates 326A, 326B, e.g., made from steel, joined by electrical resistance welding applied by electrodes 16, 18 that function as described above in reference to FIG. 1. The beam structures 322 have side openings 322O permitting the insertion of mitered ends of beam structures 324 where they are retained by welds W between the plates 326A, 326B and the structures 324.

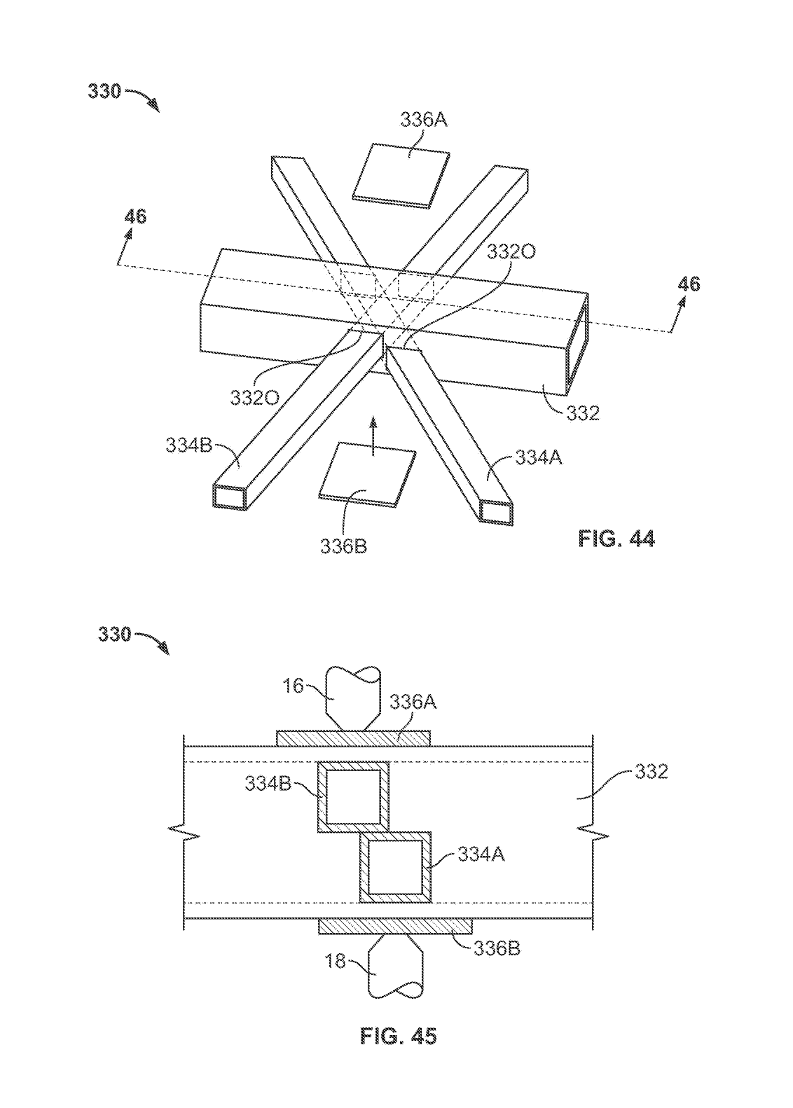

FIGS. 44 and 45 show a composite structure 330 formed from a hollow beam structure 332, e.g., made from aluminum, hollow beam structures 334A, 334B and plates 336A, 336B, e.g., made from steel, joined by electrical resistance welding applied by electrodes 16, 18 that function as described above in reference to FIG. 1. The beam structure 332 has side openings 322O permitting the insertion of beam structures 334A, 334B there through at an angle, the beams 334A, 334B being at a skew orientation relative to each other. The beams 334A, 334B are welded in place via plates 336A, 336B via electrical resistance welding. As before, the spot welds extend through the aluminum structure 332 allowing the steel structures 334A, 334B to weld to the plates 336A, 336B.

It will be understood that the embodiments described herein are merely exemplary and that a person skilled in the art may make many variations and modifications without departing from the spirit and scope of the disclosed subject matter. All such variations and modifications are intended to be included within the scope of the claims.

We claim:

1. A method for fastening a first electrically conductive body made of a first material to a second electrically conductive body being made from a second material dissimilar to the material of the first body, using electrical resistance welding, comprising:
placing the first and second bodies together in physical and electrical contact, the first material having a lower melting point than the second material;
placing an electrically conductive third body that is made of a third material that is weldable to the second material and which has a higher melting point than the first material in physical and electrical contact with the first material to form an electrically conductive stack inclusive of at least a portion of the first body, the second body and the third body;
applying an electrical potential across the stack, inducing a current to flow through the stack and causing resistive heating, the resistive heating causing a softening of a least a portion of the first body;
urging a softened portion of the third body through the softened portion of the first body toward the second body;
after the portion of the third body contacts the second body, welding the third body to the second body.

2. The method of claim 1, wherein the first material includes at least one of aluminum, magnesium and alloys thereof.

3. The method of claim 2, wherein the second material includes at least one of steel, titanium and alloys thereof.

4. The method of claim 3, wherein the third material includes at least one of steel, titanium and alloys thereof.

5. The method of claim 1, wherein a portion of the third body covers an upwelled portion of the first body that is displaced when the portion of the third body is urged through the first body.

6. The method of claim 1 wherein the first body, the second body and the third body are in the form of layers proximate where the third body is welded to the second body.

7. The method of claim 6, wherein the layers are sheet metal.

8. The method of claim 1 wherein at least one of the first body, the second body and the third body is in the form of a structural member.

9. The method of claim 1, wherein the electrical potential is applied in the course of direct resistance welding.

10. The method of claim 1, wherein the electrical potential is applied in the course of indirect resistance welding.

11. The method of claim 1, wherein the electrical potential is applied in the course of series resistance welding.

12. The method of claim 1, wherein the stack includes a plurality of bodies having a melting point less than a melting point of the second and third bodies.

13. The method of claim 1, wherein the second body and the third body are monolithic, the second body distinguishable from the third body by a fold and further including the steps of folding to make the fold and inserting the first body into the fold to make the stack prior to the step of applying an electrical potential across the stack.

14. The method of claim 13, wherein the folding results in a J shape.

15. The method of claim 13, wherein the folding results in a U shape.

16. The method of claim 13, wherein the step of folding is conducted a plurality of times to make a plurality of folds.

17. The method of claim 16, wherein the folding results in an S shape.

18. The method of claim 16, wherein the folding results in a W shape.

19. The method of claim 13, wherein a plurality of bodies are inserted into the plurality of folds.

20. The method of claim 19, wherein the step of welding simultaneously generates a plurality of welds.

21. The method of claim 13, wherein the folding results in a T shape with a bifurcated bottom portion and a top portion, and the step of inserting includes inserting the first body into the bifurcated bottom and the step of welding is conducted across the stack of the first body and the bifurcated bottom portion.

22. The method of claim 21, further comprising the step of fastening another body to the top portion of the T shape.

23. The method of claim 1, wherein current during the steps of applying, urging and welding is adjustable and further comprising the step of adjusting the current.

24. The method of claim 23, wherein a force applied during the steps of urging and welding is adjustable is adjustable and further comprising the step of adjusting the force.

25. The method of claim 24, wherein the steps of adjusting the current and the force can be made to accommodate different thickness of the first body, second body and third body.

26. The method of claim 1, wherein the third layer and the second layer are not pierced during the steps of applying, urging and welding.

27. A laminate structure, comprising:
a first electrically conductive body, a second electrically conductive body and a third electrically conductive body positioned proximate one another in physical and electrical contact, the first body having a lower melting point than the second and third bodies and being positioned between the second and third bodies, the second body being welded to the third body by electrical resistance welding extending through the first body, the first body being captured between the second body and the third body.

28. The structure of claim 27, wherein the first body is in the form of an elongated channel and the second body is in the form of a web that extends across the elongated channel and folds back over itself at a fold defining the third body, a portion of the first body positioned in the fold and retained in the fold by the welding of the second body to the third body.

29. The structure of claim 27, wherein the first body is in the form of a plate, the second and third bodies are in the form of beams having an L shaped cross-section, the first body being sandwiched between the second and third bodies.

30. The structure of claim 29 further comprising a plurality of plates and beams of L shaped cross-section.

31. The structure of claim 27, wherein the first body is in the form of an I beam, the second body is in the form of an elongated channel insertable into a hollow defined by the I shape of the first body and the third body is in the form a plate positioned on a top portion of the I shape.

32. The structure of claim 27, wherein the first, second and third bodies are each tubular, the second body capable of being inserted coaxially into at least a portion of the third body, the first body having dimensions permitting the insertion thereof between the second and third bodies.

33. The structure of claim 27, wherein the first and second bodies are each tubular, the second body having dimensions permitting the insertion thereof within the first body, the third body being a plate positioned against the exterior of the first body adjacent the second body.

34. The structure of claim 33, wherein the first and second bodies have at least one of a rectangular and circular cross-sectional shape.

35. The structure of claim 27, wherein the first body is in the form of a tube, the second body is in the form of plate positioned against the interior of the first body, the first body having an opening with dimensions permitting the insertion there through of the second body, the third body being in the form of a plate positioned against the exterior of the first body proximate the second body, sandwiching the first body there between.

36. The structure of claim 27, wherein the first body is in the form of an elongated channel and the second body is in the form of a channel that inserts into a hollow of the first body, the third body being in the form of a plate, the plate positioned proximate the second body sandwiching the first body there between.

37. The structure of claim 27, wherein the first body is in the form of an elongated channel and the second body is in the form of a tube that inserts into a hollow of the first body, the third body being in the form of a plate, the plate positioned proximate the second body, sandwiching the first body there between.

38. The structure of claim 27, wherein the first body is in the form of an elongated tube and the second body is in the form of a C shaped bracket that inserts into a hollow of the first body, the third body being in the form of a plate, the plate positioned proximate the second body, sandwiching the first body there between.

39. The structure of claim 38, wherein the first body has an aperture allowing the insertion of welding electrodes.

40. The structure of claim 27, wherein the first body is tubular and the second body is tubular, the first body having a side aperture allowing the insertion of the second body at an angle relative to the first body, the third body being in the form of a plate, the plate positioned proximate the second body, sandwiching the first body there between.

41. The structure of claim 40, wherein the first body has a tab extending therefrom proximate the side aperture.

42. The structure of claim 40, further including a fourth body similar to the second body, the second and fourth bodies being mitered and joining at the aperture.

43. The structure of claim 42, wherein the structure is replicated a plurality of times to form a truss structure.

44. The structure of claim 40, further including a fourth body similar to the second body and the first body has a second aperture, the second and fourth bodies inserting into the aperture and second aperture, respectively, along skew lines.

45. The structure of claim 27, further comprising a coating on at least one of the first material, the second material and the third material.

46. The structure of claim 45, wherein the coating is at least one of aluminum alloy, galvanized, galvaneal and anti-corrosion paint.

47. The structure of claim 45, wherein the coating is an adhesive.
